(19) United States
(12) Patent Application Publication
(10) Pub. No.: US 2007/0196406 A1
(43) Pub. Date: Aug. 23, 2007

(54) 1,3-Dimethylbutyl carboxanilides for controlling undesirable micro-organisms

(76) Inventors: Ralf Dunkel, Lyon (FR); Hans-Ludwig Elbe, Wuppertal (DE); Jorg Nico Greul, Leichlingen (DE); Benoit Hartmann, Langenfeld (DE); Ulrike Wachendorff-Neumann, Neuwied (DE); Peter Dahmen, Neuss (DE); Karl-Heinz Kuck, Langenfeld (DE)

Correspondence Address: BAYER CROPSCIENCE LP, Patent Department, 2 T .W. ALEXANDER DRIVE, RESEARCH TRIANGLE PARK, NC, 27709, US

(21) Appl. No.: 10/576,153

(22) PCT Filed: Oct. 12, 2004
(86) PCT No.: PCT/EP04/11394

§ 371 Date: Oct. 27, 2006

(30) Foreign Application Priority Data
Oct. 23, 2003 (DE) 10349502.9

(51) Int. Cl. A01N 25/00

(52) U.S. Cl. 424/405; 564/305; 544/406; 548/322.5; 548/374.1; 546/315; 549/14; 549/64; 549/13; 549/438

(57) ABSTRACT

This invention relates to novel 1,3-dimethylbutylcarboxanilides of the formula (I) 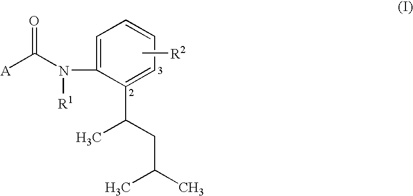
in which A, R¹ and R² are as defined in the disclosure, to a plurality of processes for preparing these compounds and their use for controlling unwanted microorganisms, and to novel intermediates and their preparation.

The present invention relates to novel 1,3-dimethylbutylcarboxanilides, to a plurality of processes for their preparation and to their use for controlling unwanted microorganisms.

It is already known that numerous carboxanilides have fungicidal properties (cf., for example, WO 03/010149, WO 02/059086, WO 02/38542, EP-A 0 824 099, EP-A 0 591 699, EP-A0 589 301, EP-A 0 545 099, JP 11-335364 and JP 10-251240), such as, for example, N-[2-(1,3-dimethylbutyl)phenyl]-5-fluoro-1,3-dimethyl-1H-pyrazole-4-carboxamide (WO 03/010149), N-allyl-N-[2-(1,3-dimethylbutyl)phenyl]-1-methyl-3-(trifluoromethyl)-1H-pyrazole-4-carboxamide (WO 02/059086), N-[2-(1,3-dimethylbutyl)phenyl]-1-methyl-4-(trifluoromethyl)-1H-pyrrole-3-carboxamide (WO 02/38542), N-[2-(1,3-dimethylbutyl)phenyl]-2-methyl-4,5-dihydrofuran-3-carboxamide (JP 11-335364). The activity of these compounds is good; however, at low application rates it is sometimes unsatisfactory.

This invention then provides novel 1,3-dimethylbutylcarboxanilides of the formula (I) 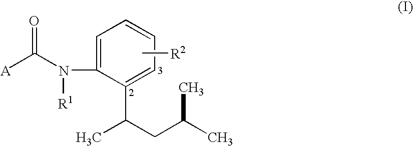
in which
R¹ represents hydrogen, C₁-C₈-alkyl, C₁-C₆-alkylsulphinyl, C₁-C₆-alkylsulphonyl, C₁-C₄-alkoxy-C₁-C₄-alkyl, C₃-C₈-cycloalkyl; C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, C₃-C₈-halocycloalkyl having in each case 1 to 9 fluorine, chlorine and/or bromine atoms; formyl, formyl-C₁-C₃-alkyl, (C₁-C₃-alkyl)carbonyl-C₁-C₃-alkyl, (C₁-C₃-alkoxy)carbonyl-C₁-C₃-alkyl; halo-(C₁-C₃-alkyl)carbonyl-C₁-C₃-alkyl, halo-(C₁-C₃-alkoxy)carbonyl-C₁-C₃-alkyl having in each case 1 to 13 fluorine, chlorine and/or bromine atoms;
   (C₁-C₈-alkyl)carbonyl, (C₁-C₈-alkoxy)carbonyl, (C₁-C₄-alkoxy-C₁-C₄-alkyl)carbonyl, (C₃-C₈-cycloalkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl, (C₃-C₈-halocycloalkyl)carbonyl having in each case 1 to 9 fluorine, chlorine and/or bromine atoms; or —C(═O)C(═O)R³, —CONR⁴R⁵ or —CH₂NR⁶R⁷,
R² represents hydrogen, fluorine, chlorine, methyl or trifluoromethyl,
R³ represents hydrogen, C₁-C₈-alkyl, C₁-C₈-alkoxy, C₁-C₄-alkoxy-C₁-C₄-alkyl, C₃-C₈-cycloalkyl; C₁-C₆-haloalkyl, C₁-C₆-haloalkoxy, halo-C₁-C₄-alkoxy-C₁-C₄-alkyl, C₃-C₈-halocycloalkyl having in each case 1 to 9 fluorine, chlorine and/or bromine atoms,
R⁴ and R⁵ independently of one another each represent hydrogen, C₁-C₈-alkyl, C₁-C₄-alkoxy-C₁-C₄-alkyl, C₃-C₈-cycloalkyl; C₁-C₈-haloalkyl, halo-C₁-C₄-alkoxy-C₁-C₄-alkyl, C₃-C₈-halocycloalkyl having in each case 1 to 9 fluorine, chlorine and/or bromine atoms,
R⁴ and R⁵ furthermore together with the nitrogen atom to which they are attached form a saturated heterocycle having 5 to 8 ring atoms which is optionally mono- or polysubstituted by identical or different substituents from the group consisting of halogen and C₁-C₄-alkyl, where the heterocycle may contain 1 or 2 further non-adjacent heteroatoms from the group consisting of oxygen, sulphur and NR⁸,
R⁶ and R⁷ independently of one another represent hydrogen, C₁-C₈-alkyl, C₃-C₈-Cycloalkyl; C₁-C₈-haloalkyl, C₃-C₈-halocycloalkyl having in each case 1 to 9 fluorine, chlorine and/or bromine atoms,
R⁶ and R⁷ furthermore together with the nitrogen atom to which they are attached form a saturated heterocycle having 5 to 8 ring atoms which is optionally mono- or polysubstituted by identical or different substituents from the group consisting of halogen and C₁-C₄-alkyl, where the heterocycle may contain 1 or 2 further non-adjacent heteroatoms from the group consisting of oxygen, sulphur and NR⁸,
R⁸ represents hydrogen or C₁-C₆-alkyl,
A represents the radical of the formula (A1) 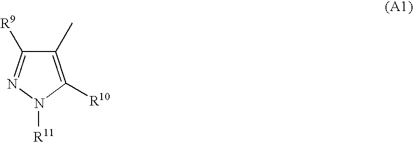
   in which
R⁹ represents hydrogen, hydroxyl, formyl, cyano, fluorine, chlorine, bromine, nitro, C₁-C₄-alkyl, C₁-C₄-alkoxy, C₁-C₄-alkylthio, C₃-C₆-Cycloalkyl, C₁-C₄-haloalkyl, C₁-C₄-haloalkoxy or C₁-C₄-haloalkylthio having in each case 1 to 5 halogen atoms, aminocarbonyl or aminocarbonyl-C₁-C₄-alkyl,
R¹⁰ represents hydrogen, chlorine, bromine, iodine, cyano, C₁-C₄-alkyl, C₁-C₄-alkoxy, C₁-C₄-alkylthio or C₁-C₄-haloalkyl having 1 to 5 halogen atoms, and
R¹¹ represents hydrogen, C₁₋₄-alkyl, hydroxy-C₁-C₄-alkyl, C₂-C₆-alkenyl, C₃-C₆-cycloalkyl, C₁-C₄-alkylthio-C₁-C₄-alkyl, C₁-C₄-alkoxy-C₁-C₄-alkyl, C₁-C₄-haloalkyl, C₁-C₄-haloalkylthio-C₁-C₄-alkyl, C₁-C₄-haloalkoxy-C₁-C₄-alkyl having in each case 1 to 5 halogen atoms, or represents phenyl,
   with the proviso,
   a) that R⁹ does not represent trifluoromethyl, difluoromethyl, methyl or ethyl if R¹⁰ represents hydrogen or chlorine, R¹¹ represents methyl and R¹ and R² simultaneously represent hydrogen,
   b) that R⁹ does not represent methyl, difluorochloromethyl, trifluoromethyl, difluoromethyl, chlorine or bromine if R¹⁰ represents hydrogen, fluorine, trifluoromethyl or methyl, R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms,
      or
      A represents the radical of the formula (A2) 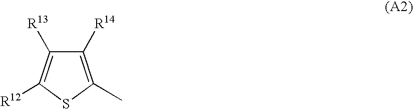
      in which
   R¹² and R¹³ independently of one another represent hydrogen, halogen, C₁-C₄-alkyl or C₁-C₄-haloalkyl having in each case 1 to 5 halogen atoms and
   R¹⁴ represents halogen, cyano or C₁-C₄-alkyl, or C₁-C₄-haloalkyl or C₁-C₄-haloalkoxy having in each case 1 to 5 halogen atoms,
   with the proviso that R¹⁴ does not represent methyl if R¹² and R¹³ represent hydrogen or methyl and R¹ and R² simultaneously represent hydrogen,
      or
      A represents the radical of the formula (A3) 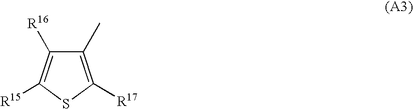
      in which
   R¹⁵ and R¹⁶ independently of one another represent hydrogen, halogen, C₁-C₄-alkyl or C₁-C₄-haloalkyl having 1 to 5 halogen atoms and
   R¹⁷ represents hydrogen, C₁-C₄-alkyl or C₁-C₄-haloalkyl having 1 to 5 halogen atoms,
      or
      A represents the radical of the formula (A4) 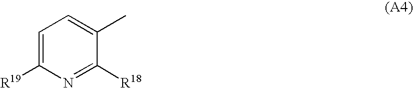
      in which
   R¹⁸ represents halogen, hydroxyl, cyano, C₁-C₄-alkyl, C₁-C₄-alkoxy, C₁-C₄-alkylthio, C₁-C₄-haloalkyl, C₁-C₄-haloalkylthio or C₁-C₄-haloalkoxy having in each case 1 to 5 halogen atoms,
   R¹⁹ represents hydrogen, halogen, cyano, C₁-C₄-alkyl, C₁-C₄-alkoxy, C₁-C₄-alkylthio, C₁-C₄-haloalkyl, C₁-C₄-haloalkoxy having in each case 1 to 5 halogen atoms, C₁-C₄-alkylsulphinyl or C₁-C₄-alkylsulphonyl,
   with the proviso,
   a) that R¹⁸ does not represent trifluoromethyl, methyl, chlorine or methylthio if R¹⁹ represents hydrogen and R¹ and R² simultaneously represent hydrogen,
   b) that R¹⁸ does not represent methyl, difluorochloromethyl, trifluoromethyl, difluoromethyl, chlorine or bromine if R¹⁹ represents hydrogen and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms,
      or
      A represents the radical of the formula (A5) 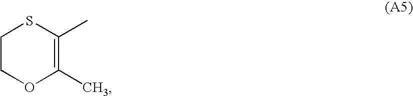
   with the proviso, that R¹ and R² do not simultaneously represent hydrogen if A represents A5,
      or
      A represents the radical of the formula (A6) 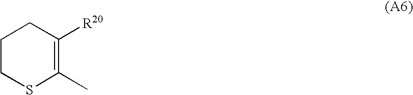
      in which
   R²⁰ represents C₁-C₄-alkyl or C₁-C₄-haloalkyl having 1 to 5 halogen atoms,
      or
      A represents the radical of the formula (A7) 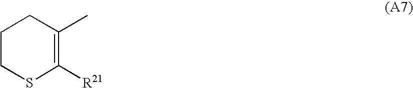
      in which
   R²¹ represents C₁-C₄-alkyl or C₁-C₄-haloalkyl having 1 to 5 halogen atoms,
      or
      A represents the radical of the formula (A8) 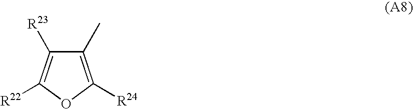
      in which
   R²² and R²³ independently of one another represent hydrogen, halogen, amino, C₁-C₄-alkyl or C₁-C₄-haloalkyl having 1 to 5 halogen atoms and
   R²⁴ represents hydrogen, C₁-C₄-alkyl or C₁-C₄-haloalkyl having 1 to 5 halogen atoms,
   with the proviso that R²⁴ does not represent methyl if R²² and R²³ represent hydrogen or methyl and R¹ and R² simultaneously represent hydrogen,
      or
      A represents the radical of the formula (A9) 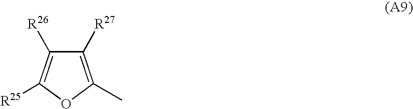
      in which
R²⁵ and R²⁶ independently of one another represent hydrogen, halogen, amino, nitro, C₁-C₄-alkyl or C₁-C₄-haloalkyl having 1 to 5 halogen atoms and
R²⁷ represents halogen, C₁-C₄-alkyl or C₁-C₄-haloalkyl having 1 to 5 halogen atoms,
   or
   A represents the radical of the formula (A 10) 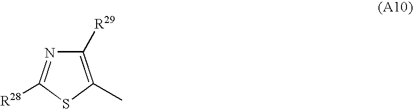
   in which
   R²⁸ represents hydrogen, halogen, amino, C₁-C₄-alkylamino, di-C₁-C₄-alkyl)amino, cyano, C₁-C₄-alkyl or C₁-C₄-haloalkyl having 1 to 5 halogen atoms and
   R²⁹ represents halogen, hydroxyl, C₁-C₄-alkyl, C₁-C₄-alkoxy, C₃-C₆-cycloalkyl, C₁-C₄-haloalkyl or C₁-C₄-haloalkoxy having in each case 1 to 5 halogen atoms,
   with the proviso,
   a) that R²⁹ does not represent trifluoromethyl, difluoromethyl, methyl or ethyl if R²⁸ represents hydrogen or methyl and R¹ and R² simultaneously represent hydrogen,
   b) that R²⁹ does not represent methyl, difluorochloromethyl, trifluoromethyl, difluoromethyl, chlorine or bromine if R²⁸ represents methyl, trifluoromethyl, methoxymethyl or trifluoromethoxymethyl and R¹ represents (C₁-C₆-alkyl)-carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)-carbonyl having in each case 1 to 9 fluorine, chlorine and/or bromine atoms,
      or
      A represents the radical of the formula (A11) 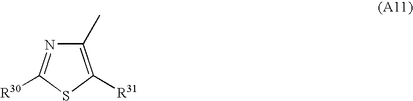
      in which
   R³⁰ represents hydrogen, halogen, amino, C₁-C₄-alkylamino, di-C₁-C₄-alkyl)amino, cyano, C₁-C₄-alkyl or C₁-C₄-haloalkyl having 1 to 5 halogen atoms and
   R³¹ represents halogen, C₁-C₄-alkyl or C₁-C₄-haloalkyl having 1 to 5 halogen atoms,
      or
      A represents the radical of the formula (A12) 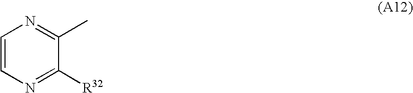
      in which
   R³² represents hydrogen, halogen, C₁-C₄-alkyl or C₁-C₄-haloalkyl having 1 to 5 halogen atoms,
   with the proviso that R³² does not represent chlorine if R¹ and R² simultaneously represent hydrogen,
      or
      A represents the radical of the formula (A13) 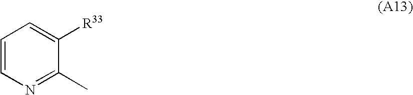
      in which
   R³³ represents halogen, hydroxyl, C₁-C₄-alkyl, C₁-C₄-alkoxy, C₁-C₄-alkylthio, C₁-C₄-haloalkyl, C₁-C₄-haloalkylthio or C₁-C₄-haloalkoxy having in each case 1 to 5 halogen atoms,
      or
      A represents the radical of the formula (A14) 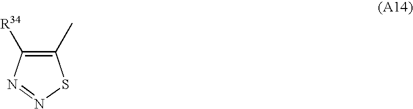
      in which
   R³⁴ represents C₁-C₄-alkyl.

The compounds according to the invention can, if appropriate, be present as mixtures of various possible isomeric forms, in particular of stereoisomers, such as, for example, E and Z, threo and erythro and also optical isomers, and, if appropriate, also of tautomers. What is claimed are both the E and Z isomers and the threo and erythro and also the optical isomers, any mixtures of these isomers and the possible tautomeric forms.

Furthermore, it has been found that 1,3-dimethylbutylcarboxanilides of the formula (I) are obtained when
a) carboxylic acid derivatives of the formula (II) 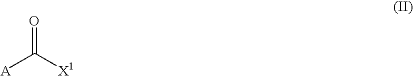
in which
A is as defined above and
X¹ represents halogen or hydroxyl,
are reacted with aniline derivatives of the formula (III) 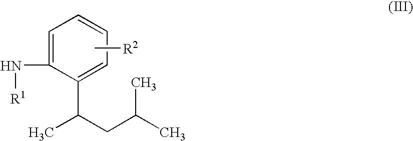
in which R¹ and R² are as defined above,
if appropriate in the presence of a catalyst, if appropriate in the presence of a condensing agent, if appropriate in the presence of an acid binder and if appropriate in the presence of a diluent,
   or
   b) hexylcarboxanilides of the formula (I-a) 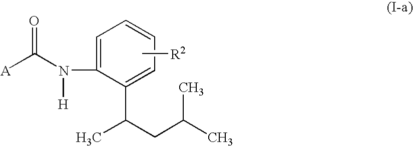
in which A and R² are as defined above, are reacted with halides of the formula (IV)
   R^{1-A}—X² (IV)
in which
X² represents chlorine, bromine or iodine,
R¹ represents C₁-C₈-alkyl, C₁-C₆-alkylsulphinyl, C₁-C₆-alkylsulphonyl, C₁-C₄-alkoxy-C₁-C₄-alkyl, C₃-C₈-cycloalkyl; C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, C₃-C₈-halocycloalkyl having in each case 1 to 9 fluorine, chlorine and/or bromine atoms; formyl, formyl-C₁-C₃-alkyl, (C₁-C₃-alkyl)carbonyl-C₁-C₃-alkyl, (C₁-C₃-alkoxy)carbonyl-C₁-C₃-alkyl; halo-(C₁-C₃-alkyl)carbonyl-C₁-C₃-alkyl, halo-(C₁-C₃-alkoxy)-carbonyl-C₁-C₃-alkyl having in each case 1 to 13 fluorine, chlorine and/or bromine atoms;
   (C₁-C₈-alkyl)carbonyl, (C₁-C₈-alkoxy)carbonyl, (C₁-C₄-alkoxy-C₁-C₄-alkyl)carbonyl, (C₃-C₈-cycloalkyl)carbonyl; (C₁-C₆-haloalkyl)carbonyl, (C₁-C₆-haloalkoxy)-carbonyl, (halo-C₁-C₄-alkoxy-C₁-C₄-alkyl)carbonyl, (C₃-C₈-halocycloalkyl)-carbonyl having in each case 1 to 9 fluorine, chlorine and/or bromine atoms; or —C(═O)C(═O)R³, CONR⁴R⁵ or —CH₂NR⁶R⁷,
   where R³, R⁴, R⁵, R⁶ and R⁷ are as defined above,
in the presence of a base and in the presence of a diluent.

Finally, it has been found that the novel 1,3-dimethylbutylcarboxanilides of the formula (I) have very good microbicidal properties and can be used for controlling unwanted microorganisms both in crop protection and in the protection of materials.

The formula (I) provides a general definition of the 1,3-dimethylbutylcarboxanilides according to the invention. Preferred radical definitions of the formulae shown above and below are given below. These definitions apply to the end products of the formula (I) and likewise to all intermediates.
R¹ preferably represents hydrogen, C₁-C₆-alkyl, C₁-C₄-alkylsulphinyl, C₁-C₄-alkylsulphonyl, C₁-C₃-alkoxy-C₁-C₃-alkyl, C₃-C₆-cycloalkyl; C₁-C₄-haloalkyl, C₁-C₄-haloalkylthio, C₁-C₄-haloalkylsulphinyl, C₁-C₄-haloalkylsulphonyl, halo-C₁-C₃-alkoxy-C₁-C₃-alkyl, C₃-C₈-halocycloalkyl having in each case 1 to 9 fluorine, chlorine and/or bromine atoms; formyl, formyl-C₁-C₃-alkyl, (C₁-C₃-alkyl)carbonyl-C₁-C₃-alkyl, (C₁-C₃-alkoxy)carbonyl-C₁-C₃-alkyl; halo-(C₁-C₃-alkyl)carbonyl-C₁-C₃-allyl, halo-(C₁-C₃-alkoxy)carbonyl-C₁-C₃-alkyl having in each case 1 to 13 fluorine, chlorine and/or bromine atoms;
   (C₁-C₆-alkyl)carbonyl, (C₁-C₄-alkoxy)carbonyl, (C₁-C₃-alkoxy-C₁-C₃-alkyl)carbonyl, (C₃-C₆-cycloalkyl)carbonyl; (C₁-C₄-haloalkyl)carbonyl, (C₁-C₄-haloalkoxy)carbonyl, (halo-C₁-C₃-alkoxy-C₁-C₃-alkyl)carbonyl, (C₃-C₆-halocycloalkyl)carbonyl having in each case 1 to 9 fluorine, chlorine and/or bromine atoms; or —C(═O)C(═O)R³, —CONR⁴R⁵ or —CH₂NR⁶.
R¹ particularly preferably represents hydrogen, methyl, ethyl, n- or isopropyl, n-, iso-, sec- or tert-butyl, pentyl or hexyl, methylsulphinyl, ethylsulphinyl, n- or isopropylsulphinyl, n-, iso-, sec- or tert-butylsulphinyl, methylsulphonyl, ethylsulphonyl, n- or isopropylsulphonyl, n-, iso-, sec- or tert-butylsulphonyl, methoxymethyl, methoxyethyl, ethoxymethyl, ethoxyethyl, cyclopropyl, cyclopentyl, cyclohexyl, trifluoromethyl, trichloromethyl, trifluoroethyl, difluoromethylthio, difluorochloromethylthio, trifluoromethylthio, trifluoromethylsulphinyl, trifluoromethylsulphonyl, trifluoromethoxymethyl; formyl, —CH₂—CHO, —(CH₂)₂—CHO, —CH₂—CO—CH₃, —CH₂—CO—CH₂CH₃, —CH₂—CO—CH(CH₃)₂, —(CH₂)₂—CO—CH₃, —(CH₂)₂—CO—CH₂CH₃, —(CH₂)₂—CO—CH(CH₃)₂, —CH₂—CO₂CH₃, —CH₂—CO₂CH₂CH₃, —CH₂—CO₂CH(CH₃)₂, —(CH₂)₂—CO₂CH₃, —(CH₂)₂—CO₂CH₂CH₃, —(CH₂)₂—CO₂CH(CH₃)₂, —CH₂—CO—CF₃, —CH₂—CO—CCl₃, —CH₂—CO—CH₂CF₃, —CH₂—CO—CH₂CCl₃, —(CH₂)₂—CO—CH₂CF₃, —(CH₂)₂—CO—CH₂CCl₃, —CH₂—CO₂CH₂CF₃, —CH₂—CO₂CF₂CF₃, CH₂—CO₂CH₂CCl₃, —CH₂—CO₂CCl₂CCl₃, —(CH₂)₂—CO₂CH₂CF₃, —(CH₂)₂—CO₂CF₂CF₃, —(CH₂)₂—CO₂CH₂CCl₃, —(CH₂)₂—CO₂CCl₂CCl₃; methylcarbonyl, ethylcarbonyl, n-propylcarbonyl, isopropylcarbonyl, tert-butylcarbonyl, methoxycarbonyl, ethoxycarbonyl, tert-butoxycarbonyl, cyclopropylcarbonyl; trifluoromethylcarbonyl, trifluoromethoxycarbonyl, or —C(═O)C(═O)R³, —CONR⁴R⁵ or —CH₂NR⁶R⁷.
R¹ very particularly preferably represents hydrogen, methyl, methoxymethyl, formyl, —CH₂—CHO, —(CH₂)₂—CHO, —CH₂—CO—CH₃, —CH₂—CO—CH₂CH₃, —CH₂—CO—CH(CH₃)₂, —C(═(O)CHO, —C(═O)C(═O)CH₃, —C(═O)C(═O)CH₂OCH₃, —C(═O)CO₂CH₃, —C(═O)CO₂CH₂CH₃.
R² preferably represents hydrogen.
R² furthermore preferably represents fluorine, where fluorine is particularly preferably located in the 4-, 5- or 6-position, very particularly preferably in the 4- or 6-position, especially in the 4-position, of the anilide radical [cf. formula (I) above].
R² furthermore preferably represents chlorine, where chlorine is particularly preferably located in the 5-position of the anilde radical [cf. formula (I) above].
R² furthermore preferably represents methyl, where methyl is particularly preferably located in the 3-position of the anilide radical [cf. formula (I) above].
R² furthermore preferably represents trifluoromethyl, where trifluoromethyl is particularly preferably located in the 4- or 5-position of the anilide radical [cf. formula (I) above].
R³ preferably represents hydrogen, C₁-C₆-alkyl, C₁-C₄-alkoxy, C₁-C₃-alkoxy-C₁-C₃-alkyl, C₃-C₆-Cycloalkyl; C₁-C₄-haloalkyl, C₁-C₄-haloalkoxy, halo-C₁-C₃-alkoxy-C₁-C₃-alkyl, C₃-C₆-halocycloalkyl having in each case 1 to 9 fluorine, chlorine and/or bromine atoms.
R³ particularly preferably represents hydrogen, methyl, ethyl, n- or isopropyl, tert-butyl, methoxy, ethoxy, n- or isopropoxy, tert-butoxy, methoxymethyl, cyclopropyl; trifluoromethyl, trifluoromethoxy.
R⁴ and R⁵ independently of one another preferably represent hydrogen, C₁-C₆-alkyl, C₁-C₃-alkoxy-C₁-C₃-alkyl, C₃-C₆-cycloalkyl; C₁-C₄-haloalkyl, halo-C₁-C₃-alkoxy-C₁-C₃-alkyl, C₃-C₆-halocycloalkyl having in each case 1 to 9 fluorine, chlorine and/or bromine atoms.
R⁴ and R⁵ furthermore together with the nitrogen atom to which they are attached preferably form a saturated heterocycle having 5 or 6 ring atoms which is optionally mono- to tetrasubstituted by identical or different substituents from the group consisting of halogen and C₁-C₄-alkyl, where the heterocycle may contain 1 or 2 further non-adjacent heteroatoms from the group consisting of oxygen, sulphur and NR⁸.
R⁴ and R⁵ independently of one another particularly preferably represent hydrogen, methyl, ethyl, n- or isopropyl, n-, iso-, sec- or tert-butyl, methoxymethyl, methoxyethyl, ethoxymethyl, ethoxyethyl, cyclopropyl, cyclopentyl, cyclohexyl; trifluoromethyl, trichloromethyl, trifluoroethyl, trifluoromethoxymethyl.
R⁴ and R⁵ furthermore together with the nitrogen atom to which they are attached particularly preferably represent a saturated heterocycle from the group consisting of morpholine, thiomorpholine and piperazine, which heterocycle is optionally mono- to tetrasubstituted by identical or different substituents from the group consisting of fluorine, chlorine, bromine and methyl, where the piperazine may be substituted by R⁸ on the second nitrogen atom.
R⁶ and R⁷ independently of one another preferably represent hydrogen, C₁-C₆-alkyl, C₃-C₆-cycloalkyl; C₁-C₄-haloalkyl, C₃-C₆-halocycloalkyl having in each case 1 to 9 fluorine, chlorine and/or bromine atoms.
R⁶ and R⁷ furthermore together with the nitrogen atom to which they are attached preferably form a saturated heterocycle having 5 or 6 ring atoms which is optionally mono- or polysubstituted by identical or different substituents from the group consisting of halogen and C₁-C₄-alkyl, where the heterocycle may contain 1 or 2 further non-adjacent heteroatoms from the group consisting of oxygen, sulphur and NR⁸.
R⁶ and R⁷ independently of one another particularly preferably represent hydrogen, methyl, ethyl, n- or isopropyl, n-, iso-, sec- or tert-butyl, methoxymethyl, methoxyethyl, ethoxymethyl, ethoxyethyl, cyclopropyl, cyclopentyl, cyclohexyl; trifluoromethyl, trichloromethyl, trifluoroethyl, trifluoromethoxymethyl.
R⁶ and R⁷ furthermore together with the nitrogen atom to which they are attached particularly preferably represent a saturated heterocycle from the group consisting of morpholine, thiomorpholine and piperazine, which heterocycle is optionally mono- to tetrasubstituted by identical or different substituents from the group consisting of fluorine, chlorine, bromine and methyl, where the piperazine may be substituted by R⁸ on the second nitrogen atom.
R⁸ preferably represents hydrogen or C₁-C₄-alkyl.
R⁸ particularly preferably represents hydrogen, methyl, ethyl, n- or isopropyl, n-, iso-, sec- or tert-butyl.
A preferably represents one of the radicals A1, A2, A3, A4, A5, A8, A9, A10, A11, A12 or A13 given above.
A particularly preferably represents one of the radicals A1, A2, A4, A5, A8, A10, A12 or A13 given above.
   A very particularly preferably represents the radical A1.
   A furthermore very particularly preferably represents the radical A2.
   A furthermore very particularly preferably represents the radical A4.
   A furthermore very particularly preferably represents the radical A5.
   A furthermore very particularly preferably represents the radical A8.
   A furthermore very particularly preferably represents the radical A10.
   A furthermore very particularly preferably represents the radical A12.
   A furthermore very particularly preferably represents the radical A13.
R⁹ preferably represents hydrogen, hydroxyl, formyl, cyano, fluorine, chlorine, bromine, methyl, ethyl, isopropyl, methoxy, ethoxy, methylthio, ethylthio, cyclopropyl, C₁-C₂-haloalkyl, C₁-C₂-haloalkoxy having in each case 1 to 5 fluorine, chlorine and/or bromine atoms, trifluoromethylthio, difluoromethylthio, aminocarbonyl, aminocarbonylmethyl or aminocarbonylethyl,
   with the proviso,
   a) that R⁹ does not represent trifluoromethyl, difluoromethyl, methyl or ethyl if R¹⁰ represents hydrogen or chlorine, R¹¹ represents methyl and R¹ and R² simultaneously represent hydrogen,
   b) that R⁹ does not represent methyl, difluorochloromethyl, trifluoromethyl, difluoromethyl, chlorine or bromine if R¹⁰ represents hydrogen, fluorine, trifluoromethyl or methyl, R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine-, chlorine- and/or bromine atoms.
R⁹ particularly preferably represents hydrogen, hydroxyl, formyl, fluorine, chlorine, bromine, methyl, ethyl, isopropyl, monofluoromethyl, monofluoroethyl, difluoromethyl, trifluoromethyl, difluorochloromethyl, trichloromethyl, pentafluoroethyl, cyclopropyl, methoxy, ethoxy, trifluoromethoxy, trichloromethoxy, difluoromethoxy, methylthio, ethylthio, trifluoromethylthio or difluoromethylthio,
   with the proviso,
   a) that R⁹ does not represent trifluoromethyl, difluoromethyl, methyl or ethyl if R¹⁰ represents hydrogen or chlorine, R¹¹ represents methyl and R¹ and R² simultaneously represent hydrogen,
   b) that R⁹ does not represent methyl, difluorochloromethyl, trifluoromethyl, difluoromethyl, chlorine or bromine if R¹⁰ represents hydrogen, fluorine, trifluoromethyl or methyl, R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine-, chlorine- and/or bromine atoms.
R⁹ very particularly preferably represents hydrogen, hydroxyl, formyl, fluorine, chlorine, bromine, methyl, isopropyl, monofluoromethyl, —CHFCH₃, difluoromethyl, trifluoromethyl, trichloromethyl, pentafluoroethyl, methoxy, trifluoromethoxy or difluoromethoxy,
   with the proviso,
   a) that R⁹ does not represent trifluoromethyl, difluoromethyl, methyl or ethyl if R¹⁰ represents hydrogen or chlorine, R¹¹ represents methyl and R¹ and R² simultaneously represent hydrogen,
   b) that R⁹ does not represent methyl, difluorochloromethyl, trifluoromethyl, difluoromethyl, chlorine or bromine if R¹⁰ represents hydrogen, fluorine, trifluoromethyl or methyl, R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine-, chlorine- and/or bromine atoms.
R⁹ especially preferably represents hydrogen, hydroxyl, formyl, chlorine, methyl, —CHFCH₃, difluoromethyl, trifluoromethyl, methoxy or difluoromethoxy
   with the proviso,
   a) that R⁹ does not represent trifluoromethyl, difluoromethyl, methyl or ethyl if R¹⁰ represents hydrogen or chlorine, R¹¹ represents methyl and R¹ and R² simultaneously represent hydrogen,
   b) that R⁹ does not represent methyl, difluorochloromethyl, trifluoromethyl, difluoromethyl, chlorine or bromine if R¹⁰ represents hydrogen, fluorine, trifluoromethyl or methyl, R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine-, chlorine- and/or bromine atoms.
R¹⁰ preferably represents hydrogen, chlorine, bromine, iodine, methyl, ethyl, methoxy, ethoxy, methylthio, ethylthio or C₁-C₂-haloalkyl having 1 to 5 halogen atoms.
R¹⁰ particularly preferably represents hydrogen, chlorine, bromine, iodine, methyl or —CHFCH₃.
R¹⁰ very particularly preferably represents hydrogen, chlorine, methyl or —CHFCH₃.
R¹¹ preferably represents hydrogen, methyl, ethyl, n-propyl, isopropyl, C₁-C₂-haloalkyl having 1 to 5 fluorine, chlorine and/or bromine atoms, hydroxymethyl, hydroxyethyl, cyclopropyl, cyclopentyl, cyclohexyl or phenyl.
R¹¹ particularly preferably represents hydrogen, methyl, ethyl, isopropyl, trifluoromethyl, difluoromethyl, hydroxymethyl, hydroxyethyl or phenyl.
R¹¹ very particularly preferably represents hydrogen, methyl, trifluoromethyl or phenyl.
R¹¹ especially preferably represents methyl.
R¹² and R¹³ independently of one another preferably represent hydrogen, fluorine, chlorine, bromine, methyl, ethyl or C₁-C₂-haloalkyl having 1 to 5 fluorine, chlorine and/or bromine atoms.
R¹² and R¹³ independently of one another particularly preferably represent hydrogen, fluorine, chlorine, bromine, methyl, ethyl, difluoromethyl, trifluoromethyl, difluorochloromethyl or trichloromethyl.
R¹² and R¹³ independently of one another very particularly preferably represent hydrogen, fluorine, chlorine, bromine or methyl.
R¹² and R¹³ especially preferably each represent hydrogen.
R¹⁴ preferably represents fluorine, chlorine, bromine, iodine, cyano, methyl, ethyl, C₁-C₂-haloalkyl or C₁-C₂-haloalkoxy having in each case 1 to 5 fluorine, chlorine and/or bromine atoms,
   with the proviso that R¹⁴ does not represent methyl if R¹² and R¹³ represent hydrogen or methyl and R¹ and R² simultaneously represent hydrogen.
R¹⁴ particularly preferably represents fluorine, chlorine, bromine, iodine, cyano, methyl, trifluoromethyl, trifluoromethoxy, difluoromethoxy, difluorochloromethoxy or trichloromethoxy,
   with the proviso that R¹⁴ does not represent methyl if R¹² and R¹³ represent hydrogen or methyl and R¹ and R² simultaneously represent hydrogen.
R¹⁴ very particularly preferably represents fluorine, chlorine, bromine, iodine, methyl, trifluoromethyl or trifluoromethoxy,
   with the proviso that R¹⁴ does not represent methyl if R¹² and R¹³ represent hydrogen or methyl and R¹ and R² simultaneously represent hydrogen.
R¹⁴ especially preferably represents chlorine, iodine or methyl,
   with the proviso that R¹⁴ does not represent methyl if R¹² and R¹³ represent hydrogen or methyl and R¹ and R² simultaneously represent hydrogen.
R¹⁵ and R¹⁶ independently of one another preferably represent hydrogen, fluorine, chlorine, bromine, methyl, ethyl or C₁-C₂-haloalkyl having 1 to 5 fluorine, chlorine and/or bromine atoms.
R¹⁵ and R¹⁶ independently of one another particularly preferably represent hydrogen, fluorine, chlorine, bromine, methyl, ethyl, difluoromethyl, trifluoromethyl, difluorochloromethyl or trichloromethyl.
R¹⁵ and R¹⁶ independently of one another very particularly preferably represent hydrogen, fluorine, chlorine, bromine or methyl.
R¹⁵ and R¹⁶ especially preferably each represent hydrogen.
R¹⁷ preferably represents hydrogen, methyl, ethyl or C₁-C₂-haloalkyl having 1 to 5 fluorine, chlorine and/or bromine atoms.
R¹⁷ particularly preferably represents hydrogen, methyl or trifluoromethyl.
R¹⁷ very particularly preferably represents methyl.
R¹⁸ preferably represents fluorine, chlorine, bromine, iodine, hydroxyl, cyano, C₁-C₄-alkyl, methoxy, ethoxy, methylthio, ethylthio, difluoromethylthio, trifluoromethylthio, C₁-C₂-haloalkyl or C₁-C₂-haloalkoxy having in each case 1 to 5 fluorine, chlorine and/or bromine atoms,
   with the proviso,
   a) that R¹⁸ does not represent trifluoromethyl, methyl, chlorine or methylthio if R¹⁹ represents hydrogen,
   b) that R¹⁸ does not represent methyl, difluorochloromethyl, trifluoromethyl, difluoromethyl, chlorine or bromine if R¹⁹ represents hydrogen and R¹ represents (C₁-C₆-alkyl)carbonyl, (C₁-C₆-alkoxy)carbonyl, (C₁-C₄-alkoxy-C₁-C₄-alkyl)-carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms.
R¹⁸ particularly preferably represents fluorine, chlorine, bromine, iodine, hydroxyl, cyano, methyl, ethyl, n-propyl, isopropyl, n-butyl, isobutyl, sec-butyl, tert-butyl, trifluoromethyl, difluoromethyl, difluorochloromethyl, trichloromethyl, methoxy, ethoxy, methylthio, ethylthio, difluoromethylthio, trifluoromethylthio, trifluoromethoxy, difluoromethoxy, difluorochloromethoxy or trichloromethoxy
   with the proviso,
   a) that R¹⁸ does not represent trifluoromethyl, methyl, chlorine or methylthio if R¹⁹ represents hydrogen,
   b) that R¹⁸ does not represent methyl, difluorochloromethyl, trifluoromethyl, difluoromethyl, chlorine or bromine if R¹⁹ represents hydrogen and R¹ represents (C₁-C₆-alkyl)carbonyl, (C₁-C₆-alkoxy)carbonyl, (C₁-C₄-alkoxy-C₁-C₄-alkyl)-carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms.
R¹⁸ very particularly preferably represents fluorine, chlorine, bromine, iodine, methyl, trifluoromethyl, difluoromethyl or trichloromethyl
   with the proviso,
   a) that R¹⁸ does not represent trifluoromethyl, methyl, chlorine or methylthio if R¹⁹ represents hydrogen,
   b) that R¹⁸ does not represent methyl, difluorochloromethyl, trifluoromethyl, difluoromethyl, chlorine or bromine if R¹⁹ represents hydrogen and R¹ represents (C₁-C₆-alkyl)carbonyl, (C₁-C₆-alkoxy)carbonyl, (C₁-C₄-alkoxy-C₁-C₄-alkyl)-carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms.
R¹⁹ preferably represents hydrogen, fluorine, chlorine, bromine, iodine, cyano, C₁-C₄-alkyl, methoxy, ethoxy, methylthio, ethylthio, C₁-C₂-haloalkyl or C₁-C₂-haloalkoxy having in each case 1 to 5 fluorine, chlorine and/or bromine atoms, C₁-C₂-alkylsulphinyl or C₁-C₂-alkylsulphonyl.
R¹⁹ particularly preferably represents hydrogen, fluorine, chlorine, bromine, iodine, cyano, methyl, ethyl, n-propyl, isopropyl, n-butyl, isobutyl, sec-butyl, tert-butyl, trifluoromethyl, difluoromethyl, difluorochloromethyl, trichloromethyl, methoxy, ethoxy, methylthio, ethylthio, trifluoromethoxy, difluoromethoxy, difluorochloromethoxy, trichloromethoxy, methylsulphinyl or methylsulphonyl.
R¹⁹ very particularly preferably represents hydrogen, fluorine, chlorine, bromine, iodine, methyl, ethyl, n-propyl, isopropyl, n-butyl, isobutyl, sec-butyl, tert-butyl, trifluoromethyl, difluoromethyl, trichloromethyl, methylsulphinyl or methylsulphonyl.
R¹⁹ especially preferably represents hydrogen.
R²⁰ preferably represents methyl, ethyl or C₁-C₂-haloalkyl having 1 to 5 fluorine, chlorine and/or bromine atoms.
R²⁰ particularly preferably represents methyl, trifluoromethyl, difluoromethyl, difluorochloromethyl or trichloromethyl.
R²¹ preferably represents methyl, ethyl or C₁-C₂-haloalkyl having 1 to 5 fluorine, chlorine and/or bromine atoms.
R²¹ particularly preferably represents methyl, trifluoromethyl, difluoromethyl, difluorochloromethyl or trichloromethyl.
R²² and R²³ independently of one another preferably represent hydrogen, fluorine, chlorine, bromine, amino, methyl, ethyl or C₁-C₂-haloalkyl having 1 to 5 fluorine, chlorine and/or bromine atoms.
R²² and R²³ independently of one another particularly preferably represent hydrogen, fluorine, chlorine, bromine, methyl, ethyl, trifluoromethyl, difluoromethyl, difluorochloromethyl or trichloromethyl.
R²² and R²³ independently of one another very particularly preferably represent hydrogen, fluorine, chlorine, bromine or methyl.
R²² and R²³ especially preferably each represent hydrogen.
R²⁴ preferably represents hydrogen, methyl, ethyl or C₁-C₂-haloalkyl having 1 to 5 fluorine, chlorine and/or bromine atoms,
   with the proviso that R²⁴ does not represent methyl if R²² and R²³ represent hydrogen or methyl and R¹ and R² simultaneously represent hydrogen.
R²⁴ particularly preferably represents hydrogen, methyl, ethyl, trifluoromethyl, difluoromethyl, difluorochloromethyl or trichloromethyl,
   with the proviso that R²⁴ does not represent methyl if R²² and R²³ represent hydrogen or methyl and R¹ and R² simultaneously represent hydrogen.
R²⁴ very particularly preferably represents hydrogen, methyl, trifluoromethyl, difluoromethyl or trichloromethyl,
   with the proviso that R²⁴ does not represent methyl if R²² and R²³ represent hydrogen or methyl and R¹ and R² simultaneously represent hydrogen.
R²⁴ especially preferably represents methyl or trifluoromethyl,
   with the proviso that R²⁴ does not represent methyl if R²² and R²³ represent hydrogen or methyl and R¹ and R² simultaneously represent hydrogen.
R²⁵ and R²⁶ independently of one another preferably represent hydrogen, fluorine, chlorine, bromine, amino, nitro, methyl, ethyl or C₁-C₂-haloalkyl having 1 to 5 fluorine, chlorine and/or bromine atoms.
R²⁵ and R²⁶ independently of one another particularly preferably represent hydrogen, fluorine, chlorine, bromine, nitro, methyl, ethyl, trifluoromethyl, difluoromethyl, difluorochloromethyl or trichloromethyl.
R²⁵ and R²⁶ independently of one another very particularly preferably represent hydrogen, fluorine, chlorine, bromine or methyl.
R²⁵ and R²⁶ especially preferably each represent hydrogen.
R²⁷ preferably represents fluorine, chlorine, bromine, methyl, ethyl or C₁-C₂-haloalkyl having 1 to 5 fluorine, chlorine and/or bromine atoms.
R²⁷ particularly preferably represents fluorine, chlorine, bromine, methyl, ethyl, trifluoromethyl, difluoromethyl, difluorochloromethyl or trichloromethyl.
R²⁷ very particularly preferably represents fluorine, chlorine, bromine, methyl, trifluoromethyl, difluoromethyl or trichloromethyl.
R²⁷ especially preferably represents methyl.
R²⁸ preferably represents hydrogen, fluorine, chlorine, bromine, amino, C₁-C₄-alkylamino, di(C₁-C₄-alkyl)amino, cyano, methyl, ethyl or C₁-C₂-haloalkyl having 1 to 5 fluorine, chlorine and/or bromine atoms.
R²⁸ particularly preferably represents hydrogen, fluorine, chlorine, bromine, amino, methylamino, dimethylamino, cyano, methyl, ethyl, trifluoromethyl, difluoromethyl, difluorochloromethyl or trichloromethyl.
R²⁸ very particularly preferably represents hydrogen, fluorine, chlorine, bromine, amino, methylamino, dimethylamino, methyl, trifluoromethyl, difluoromethyl or trichloromethyl.
R²⁸ especially preferably represents hydrogen, chlorine, amino, methylamino, dimethylamino, methyl or trifluoromethyl.
R²⁹ preferably represents fluorine, chlorine, bromine, hydroxyl, methyl, ethyl, methoxy, ethoxy, cyclopropyl or C₁-C₂-haloalkyl or C₁-C₂-haloalkoxy having in each case 1 to 5 fluorine, chlorine and/or bromine atoms,
   with the proviso,
   a) that R²⁹ does not represent trifluoromethyl, difluoromethyl, methyl or ethyl if R²⁸ represents hydrogen or methyl and R¹ and R² simultaneously represent hydrogen,
   b) that R²⁹ does not represent methyl, difluorochloromethyl, trifluoromethyl, difluoromethyl, chlorine or bromine if R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms.
R²⁹ particularly preferably represents fluorine, chlorine, bromine, hydroxyl, methyl, ethyl, methoxy, ethoxy, cyclopropyl, trifluoromethyl, difluoromethyl, difluorochloromethyl, trichloromethyl, trifluoromethoxy or difluoromethoxy,
   with the proviso,
   a) that R²⁹ does not represent trifluoromethyl, difluoromethyl, methyl or ethyl if R²⁸ represents hydrogen or methyl and R¹ and R² simultaneously represent hydrogen,
   b) that R²⁹ does not represent methyl, difluorochloromethyl, trifluoromethyl, difluoromethyl, chlorine or bromine if R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms.
R²⁹ very particularly preferably represents fluorine, chlorine, bromine, hydroxyl, methyl, methoxy, cyclopropyl, trifluoromethyl, difluoromethyl, trifluoromethoxy or difluoromethoxy
   with the proviso,
   a) that R²⁹ does not represent trifluoromethyl, difluoromethyl, methyl or ethyl if R²⁸ represents hydrogen or methyl and R¹ and R² simultaneously represent hydrogen,
   b) that R²⁹ does not represent methyl, difluorochloromethyl, trifluoromethyl, difluoromethyl, chlorine or bromine if R¹¹ represents methyl, trifluoromethyl, methoxymethyl or trifluoromethoxymethyl and R¹ represents (C₁-C₆-alkyl)carbonyl, (C₁-C₆-alkoxy)carbonyl, (C₁-C₄-alkoxy-C₁-C₄-alkyl)carbonyl; (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine and/or bromine atoms.
R³⁰ preferably represents hydrogen, fluorine, chlorine, bromine, amino, C₁-C₄-alkylamino, di(C₁-C₄-alkyl)amino, cyano, methyl, ethyl or C₁-C₂-haloalkyl having 1 to 5 fluorine, chlorine and/or bromine atoms.
R³⁰ particularly preferably represents hydrogen, fluorine, chlorine, bromine, amino, methylamino, dimethylamino, cyano, methyl, ethyl, trifluoromethyl, difluoromethyl, difluorochloromethyl or trichloromethyl.
R³⁰ very particularly preferably represents hydrogen, fluorine, chlorine, bromine, amino, methylamino, dimethylamino, methyl, trifluoromethyl, difluoromethyl or trichloromethyl.
R³⁰ especially preferably represents amino, methylamino, dimethylamino, methyl or trifluoromethyl.
R³¹ preferably represents fluorine, chlorine, bromine, methyl, ethyl or C₁-C₂-haloalkyl having 1 to 5 fluorine, chlorine and/or bromine atoms.
R³¹ particularly preferably represents fluorine, chlorine, bromine, methyl, ethyl, trifluoromethyl, difluoromethyl, difluorochloromethyl or trichloromethyl.
R³¹ very particularly preferably represents fluorine, chlorine, bromine, methyl, trifluoromethyl, difluoromethyl or trichloromethyl.
R³¹ especially preferably represents methyl, trifluoromethyl or difluoromethyl.
R³² preferably represents hydrogen, fluorine, chlorine, bromine, methyl, ethyl or C₁-C₂-haloalkyl having 1 to 5 fluorine, chlorine and/or bromine atoms,
   with the proviso that R³² does not represent chlorine if R¹ and R² simultaneously represent hydrogen.
R³² particularly preferably represents hydrogen, fluorine, chlorine, bromine, methyl or trifluoromethyl,
   with the proviso that R³² does not represent chlorine if R¹ and R² simultaneously represent hydrogen.
R³³ preferably represents fluorine, chlorine, bromine, iodine, hydroxyl, C₁-C₄-alkyl, methoxy, ethoxy, methylthio, ethylthio, difluoromethylthio, trifluoromethylthio, C₁-C₂-haloalkyl or C₁-C₂-haloalkoxy having in each case 1 to 5 fluorine, chlorine and/or bromine atoms.
R³³ particularly preferably represents fluorine, chlorine, bromine, iodine, methyl, ethyl, n-propyl, isopropyl, n-butyl, isobutyl, sec-butyl, tert-butyl, trifluoromethyl, difluoromethyl, difluorochloromethyl, trichloromethyl.
R³³ very particularly preferably represents fluorine, chlorine, bromine, iodine, methyl, trifluoromethyl, difluoromethyl or trichloromethyl.
R³⁴ preferably represents methyl, ethyl, n-propyl or isopropyl.
R³⁴ particularly preferable represents methyl or ethyl.

Emphasis is given to compounds of the formula (I) in which R¹ represents hydrogen.

Emphasis is given to compounds of the formula (I), in which R¹ represents formyl.

Emphasis is furthermore given to compounds of the formula (I) in which R¹ represents —C(═O)C(═O)R³, where R³ is as defined above.

Emphasis is given to compounds of the formula (I) in which A represents A1.

Saturated or unsaturated hydrocarbon radicals, such as alkyl or alkenyl, can in each case be straight-chain or branched as far as this is possible, including in combination with heteroatoms, such as, for example, in alkoxy.

Optionally substituted radicals can be mono- or polysubstituted, where in the case of polysubstitution the substituents can be identical or different.

Halogen-substituted radicals, such as, for example, haloalkyl, are mono- or polyhalogenated. In the case of polyhalogenation, the halogen atoms can be identical or different. Here, halogen denotes fluorine, chlorine, bromine and iodine, in particular fluorine, chlorine and bromine.

However, the general or preferred radical definitions or illustrations given above can also be combined with one another as desired, i.e. including between the respective ranges and preferred ranges. The definitions apply both to the end products and, correspondingly, to the precursors and intermediates.

The given definitions can be combined with one another as desired. Moreover, individual definitions may not apply.

Preferred, particularly preferred and very particularly preferred are compounds of the formula (I) which carry the substituents mentioned as being preferred, particularly preferred and very particularly preferred, respectively.

Description of the Processes According to the Invention for Preparing the Hexylcarboxanilides of the Formula (I) and the Intermediates

Process (a)

Using 4-methoxy-2-methyl-1,3-thiazole-5-carbonyl chloride and [2-(1,3-dimethylbutyl)phenyl]-amine as starting materials, the process (a) according to the invention can be illustrated by the following formula scheme:

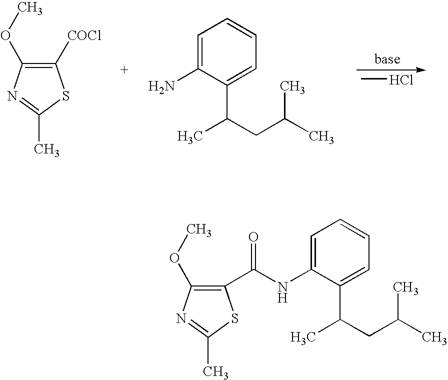

The formula (II) provides a general definition of the carboxylic acid derivatives required as starting materials for carrying out the process (a) according to the invention. In this formula (II) A preferably, particularly preferably and very particularly preferably has those meanings which have already been mentioned in connection with the description of the formula (I) according to the invention as being preferred, particularly preferred and very particularly preferred, respectively, for A. X¹ preferably represents chlorine, bromine or hydroxyl.

Most of the carboxylic acid derivatives of the formula (II) are known and/or they can be prepared by known processes (cf. WO 93/11117, EP-A 0 545 099, EP-A 0 589 301 and EP-A 0 589 313).

3-Dichloromethyl-1H-pyrazole-4-carboxylic acid derivatives of the formula (II-a) 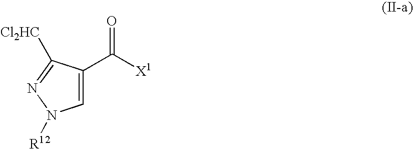
in which
R¹² and X¹ are as defined above can be obtained when,
in a first step, ketoacetals of the formula (V) 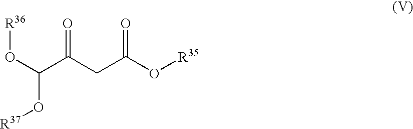
in which
R³⁵ represents C₁-C₄-alkyl, preferably methyl, ethyl, n-, isopropyl, n-, sec-, tert-butyl,
R³⁶ and R³⁷ each represent methyl or ethyl, or
R³⁶ and R³⁷ together represent —(CH₂)₃— or —CH₂—C(CH₃)₂—CH₂—
are reacted with alkyl orthoformates of the formula (VI)
HC—(OR³⁸)₃ (VI)
in which
R³⁸ represents C₁-C₄-alkyl, preferably methyl, ethyl, n-, isopropyl, n-, sec-, tert-butyl in the presence of an anhydride (for example acetic anhydride) and the resulting compound of the formula (VII) 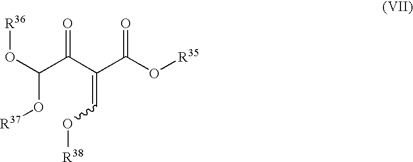
in which R³⁵, R³⁶, R³⁷ and R³⁸ are as defined above
are, in a second step, reacted with hydrazine derivatives of the formula (VIII)
R¹²—NH—NH₂ (VIII)
in which R¹² is as defined above
in the presence of a diluent (for example methanol)
and the resulting pyrazole derivatives of the formula (IX) 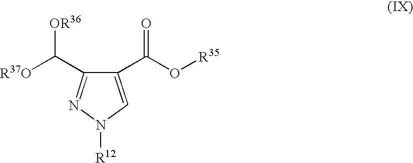
in which R¹², R³⁵, R³⁶ and R³⁷ are as defined above
are, in a third step, reacted in the presence of an acid (for example hydrochloric acid) and in the presence of a diluent (for example dioxane)
and the resulting 3-formyl-1H-pyrazole-4-carboxylic esters of the formula (X) 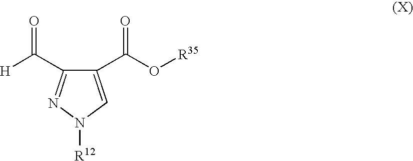
in which R¹² and R³⁵ are as defined above
are either
a) in a fourth step, hydrolysed in the presence of a base (for example lithium hydroxide) and in the presence of a diluent (for example tetrahydrofuran)
   and the resulting 3-formyl-1H-pyrazole-4-carboxylic acids of the formula (XI) 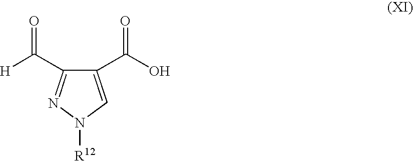
   in which R¹² is as defined above
   are then reacted with a chlorinating agent (for example phosphorus pentachloride) in the presence of a diluent (for example dichloromethane)
      or
b) are, in a fourth step, reacted with a chlorinating agent (for example phosphorus pentachloride) in the presence of a diluent
   and the resulting 3-dichlormethyl-1H-pyrazole-4-carboxylic esters of the formula (XII) 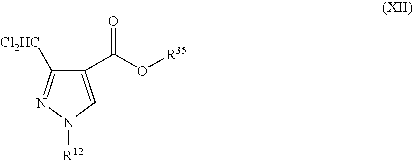
   in which R¹² and R³⁵ are as defined above
   are then hydrolysed in the presence of a base (for example lithium hydroxide) and in the presence of a diluent (for example tetrahydrofuran).

The formula (III) provides a general definition of the aniline derivatives furthermore required as starting materials for carrying out the process (a) according to the invention. In this formula (III), R¹ and R² preferably, particularly preferably and very particularly preferably have those meanings which have already been mentioned in connection with the description of the compounds of the formula (I) according to the invention as being preferred, particularly preferred and very particularly preferred, respectively, for these radicals.

The aniline derivatives of the formula (III) are known and/or can be obtained by known processes (cf. EP-A 0 824 099, WO 02/059086, WO 03/010149). Aniline derivatives of the formula (II) in which R¹ does not represent hydrogen can be prepared, for example, by reacting
aniline derivatives of the formula (III-a) 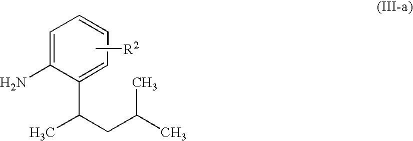
in which R² is as defined above
with halides of the formula (IV)
R^{1-A}—X² (IV)
in which R^{1-A} is as defined above
in the presence of a base and in the presence of a diluent. [The reaction conditions of process (b) apply correspondingly.]
Process (b)

Using 1,3,5-trimethyl-N-[2-(1,3-dimethylbutyl)phenyl]-1H-pyrazole-4-carboxamide and ethyl chloro(oxo)acetate as starting materials, the course of the process (b) according to the invention can be illustrated by the formula scheme below:

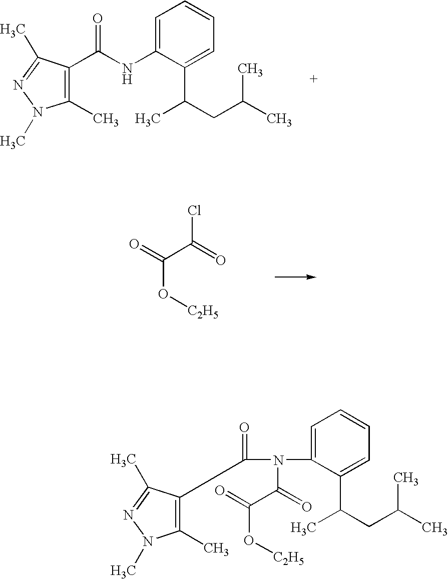

The formula (I-a) provides a general definition of the hexylcarboxanilides required as starting materials for carrying out the process (b) according to the invention. In this formula (I-a), R² and A preferably, particularly preferably and very particularly preferably have those meanings which have already been mentioned in connection with the description of the compounds of the formula (I) according to the invention as being preferred, particularly preferred and very particularly preferred, respectively, for these radicals.

The hexylcarboxanilides of the formula (I-a) are likewise compounds according to the invention and form part of the subject-matter of this application. They can be obtained by process (a) according to the invention (where R¹=hydrogen).

The formula (IV) provides a general definition of the halides furthermore required as starting materials for carrying out the process (b) according to the invention.
R^{1-A} preferably represents C₁-C₆-alkyl, C₁-C₄-alkylsulphinyl, C₁-C₄-alkylsulphonyl, C₁-C₃-alkoxy-C₁-C₃-alkyl, C₃-C₆-cycloalkyl; C₁-C₄-haloalkyl, C₁-C₄-haloalkylthio, C₁-C₄-haloalkylsulphinyl, C₁-C₄-haloalkylsulphonyl, halo-C₁-C₃-alkoxy-C₁-C₃-alkyl, C₃-C₈-halocycloalkyl having in each case 1 to 9 fluorine, chlorine and/or bromine atoms; formyl, formyl-C₁-C₃-alkyl, (C₁-C₃-alkyl)carbonyl-C₁-C₃-alkyl, (C₁-C₃-alkoxy)carbonyl-C₁-C₃-alkyl; halo-(C₁-C₃-alkyl)carbonyl-C₁-C₃-alkyl, halo-(C₁-C₃-alkoxy)carbonyl-C₁-C₃-alkyl having in each case 1 to 13 fluorine, chlorine and/or bromine atoms;
   (C₁-C₆-alkyl)carbonyl, (C₁-C₄-alkoxy)carbonyl, (C₁-C₃-alkoxy-C₁-C₃-alkyl)carbonyl, (C₃-C₆-cycloalkyl)carbonyl; (C₁-C₄-haloalkyl)carbonyl, (C₁-C₄-haloalkoxy)carbonyl, (halo-C₁-C₃-alkoxy-C₁-C₃-alkyl)carbonyl, (C₃-C₆-halocycloalkyl)carbonyl having in each case 1 to 9 fluorine, chlorine and/or bromine atoms; or —C(═O)C(═O)R³, —CONR⁴R⁵ or —CH₂NR⁶R⁷.
R^{1-A} particularly preferably represents methyl, ethyl, n- or isopropyl, n-, iso-, sec- or tert-butyl, pentyl or hexyl, methylsulphinyl, ethylsulphinyl, n- or isopropylsulphinyl, n-, iso-, sec- or tert-butylsulphinyl, methylsulphonyl, ethylsulphonyl, n- or isopropylsulphonyl, n-, iso-, sec- or tert-butylsulphonyl, methoxymethyl, methoxyethyl, ethoxymethyl, ethoxyethyl, cyclopropyl, cyclopentyl, cyclohexyl, trifluoromethyl, trichloromethyl, trifluoroethyl, difluoromethylthio, difluorochloromethylthio, trifluoromethylthio, trifluoromethylsulphinyl, trifluoromethylsulphonyl, trifluoromethoxymethyl; formyl, —CH₂—CHO, —(CH₂)₂—CHO, —CH₂—CO—CH₃, —CH₂—CO—CH₂CH₃, —CH₂—CO—CH(CH₃)₂, —(CH₂)₂—CO—CH₃, —(CH₂)₂—CO—CH₂CH₃, —(CH₂)₂—CO—CH(CH₃)₂, —CH₂—CO₂CH₃, —CH₂—CO₂CH₂CH₃, —CH₂—CO₂CH(CH₃)₂, —(CH₂)₂—CO₂CH₃, —(CH₂)₂—CO₂CH₂CH₃, —(CH₂)₂—CO₂CH(CH₃)₂, —CH₂—CO—CF₃, —CH₂—CO—CCl₃, —CH₂—CO—CH₂CF₃, —CH₂—CO—CH₂CCl₃, —(CH₂)₂—CO—CH₂CF₃, —(CH₂)₂—CO—CH₂CCl₃, —CH₂—CO₂CH₂CF₃, —CH₂—CO₂CF₂CF₃, —CH₂—CO₂CH₂CCl₃, —CH₂—CO₂CCl₂CCl₃, —(CH₂)₂—CO₂CH₂CF₃, —(CH₂)₂—CO₂CF₂CF₃, —(CH₂)₂—CO₂CH₂CCl₃, —(CH₂)₂—CO₂CCl₂CCl₃;
   methylcarbonyl, ethylcarbonyl, n-propylcarbonyl, isopropylcarbonyl, tert-butylcarbonyl, methoxycarbonyl, ethoxycarbonyl, tert-butoxycarbonyl, cyclopropylcarbonyl; trifluoromethylcarbonyl, trifluoromethoxycarbonyl, or —C(═O)C(═O)R³, —CONR⁴R⁵ or —CH₂NR⁶R⁷.
R^{1-A} very particularly preferably represents methyl, methoxymethyl, formyl, —CH₂—CHO, —(CH₂)₂—CHO, —CH₂—CO—CH₃, —CH₂—CO—CH₂CH₃, —CH₂—CO—CH(CH₃)₂, —C(═O)CHO, —C(═O)C(═O)CH₃, —C(═O)C(═O)CH₂OCH₃, —C(═O)CO₂CH₃, —C(═O)CO₂CH₂CH₃.
   X² preferably represents chlorine or bromine.

Halides of the formula (IV) are known.

Reaction Conditions

Suitable diluents for carrying out the process (a) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl-tert-butyl ether, methyl tert-amyl ether, dioxane, tetrahydrofuran, 1,2-dimethoxyethane, 1,2-diethoxyethane or anisole, or amides such as N,N-dimethylformamide, N,N-dimethylacetamide, N-methylformanilide, N-methylpyrrolidone or hexamethylphosphoric triamide.

The process (a) according to the invention is, if appropriate, carried out in the presence of a suitable acid acceptor. Suitable acid acceptors are all customary inorganic or organic bases. These preferably include alkaline earth metal or alkali metal hydrides, hydroxides, amides, alkoxides, acetates, carbonates or bicarbonates, such as, for example, sodium hydride, sodium amide, sodium methoxide, sodium ethoxide, potassium tert-butoxide, sodium hydroxide, potassium hydroxide, ammonium hydroxide, sodium acetate, potassium acetate, calcium acetate, ammonium acetate, sodium carbonate, potassium carbonate, potassium bicarbonate, sodium bicarbonate or ammonium carbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

The process (a) according to the invention is, if appropriate, carried out in the presence of a suitable condensing agent. Suitable condensing agents are all condensing agents customarily used for such amidation reactions. Acid halide formers, such as phosgene, phosphorus tribromide, phosphorus trichloride, phosphorus pentachloride, phosphorus oxychloride or thionyl chloride; anhydride formers, such as ethyl chloroformate, methyl chloroformate, isopropyl chloroformate, isobutyl chloroformate or methanesulphonyl chloride; carbodiimides, such as N,N′-dicyclohexyl-carbodiimide (DCC) or other customary condensing agents, such as phosphorus pentoxide, polyphosphoric acid, N,N′-carbonyldiimidazole, 2-ethoxy-N-ethoxycarbonyl-1,2-dihydroquinoline (EEDQ), triphenylphosphine/carbon tetrachloride or bromotripyrrolidinophosphonium hexafluoro-phosphate may be mentioned by way of example.

The process (a) according to the invention is, if appropriate, carried out in the presence of a catalyst. Examples which may be mentioned are 4-dimethylaminopyridine, 1-hydroxybenzotriazole or dimethylformamide.

When carrying out the process (a) according to the invention, the reaction temperatures may be varied within a relatively wide range. In general, the process is carried out at temperatures of from 0° C. to 150° C., preferably at temperatures of from 0° C. to 80° C.

For carrying out the process (a) according to the invention for preparing the compounds of the formula (I), in general from 0.2 to 5 mol, preferably from 0.5 to 2 mol, of aniline derivative of the formula (III) are employed per mole of the carboxylic acid derivative of the formula (II).

Suitable diluents for carrying out the process (b) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl tert-butyl ether, methyl tert-amyl ether, dioxane, tetrahydrofuran, 1,2-dimethoxyethane, 1,2-diethoxyethane or anisole, or amides, such as N,N-dimethylformamide, N,N-dimethylacetamide, N-methylformanilide, N-methylpyrrolidone or hexamethylphosphoric triamide.

The process (b) according to the invention is carried out in the presence of a base. Suitable bases are all customary inorganic or organic bases. These preferably include alkaline earth metal or alkali metal hydrides, hydroxides, amides, alkoxides, acetates, carbonates or bicarbonates, such as, for example, sodium hydride, sodium amide, sodium methoxide, sodium ethoxide, potassium tert-butoxide, sodium hydroxide, potassium hydroxide, ammonium hydroxide, sodium acetate, potassium acetate, calcium acetate, ammonium acetate, sodium carbonate, potassium carbonate, potassium bicarbonate, sodium bicarbonate, or caesium carbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

When carrying out the process (b) according to the invention, the reaction temperatures can be varied within a relatively wide range. In general, the process is carried out at temperatures of from 0° C. to 150° C., preferably at temperatures of from 20° C. to 110° C.

For carrying out the process (b) according to the invention for preparing the compounds of the formula (I), in general from 0.2 to 5 mol, preferably from 0.5 to 2 mol, of halide of the formula (V) are employed per mole of the hexylcarboxanilide of the formula (I-a).

Unless indicated otherwise, all processes according to the invention are generally carried out under atmospheric pressure. However, it is also possible to operate under elevated or reduced pressure—in general between 0.1 bar and 10 bar.

The compounds according to the invention have potent microbicidal activity and can be employed for controlling unwanted microorganisms, such as fungi and bacteria, in crop protection and in the protection of materials.

Fungicides can be employed in crop protection for controlling Plasmodiophoromycetes, Oomycetes, Chytridiomycetes, Zygomycetes, Ascomycetes, Basidiomycetes and Deuteromycetes.

Bactericides can be employed in crop protection for controlling Pseudomonadaceae, Rhizobiaceae, Enterobacteriaceae, Corynebacteriaceae and Streptomycetaceae.

Some pathogens causing fungal and bacterial diseases which come under the generic names listed above may be mentioned as examples, but not by way of limitation:

Xanthomonas species, such as, for example, Xanthomonas campestris pv. oryzae;

Pseudomonas species, such as, for example, Pseudomonas syringae pv. lachrymans;

Erwinia species, such as, for example, Erwinia amylovora;

Pythium species, such as, for example, Pythium ultimum;

Phytophthora species, such as, for example, Phytophthora infestans;

Pseudoperonospora species, such as, for example, Pseudoperonospora humuli or Pseudoperonospora cubensis;

Plasmopara species, such as, for example, Plasmopara viticola;

Bremia species, such as, for example, Bremia lactucae;

Peronospora species, such as, for example, Peronospora pisi or P. brassicae;

Erysiphe species, such as, for example, Erysiphe graminis;

Sphaerotheca species, such as, for example, Sphaerotheca fuliginea;

Podosphaera species, such as, for example, Podosphaera leucotricha;

Venturia species, such as, for example, Venturia inaequalis;

Pyrenophora species, such as, for example, Pyrenophora teres or P. graminea (conidia form: Drechslera, syn: Helminthosporium);

Cochliobolus species, such as, for example, Cochliobolus sativus (conidia form: Drechslera, syn: Helminthosporium);

Uromyces species, such as, for example, Uromyces appendiculatus;

Puccinia species, such as, for example, Puccinia recondita;

Sclerotinia species, such as, for example, Sclerotinia sclerotiorum;

Tilletia species, such as, for example, Tilletia caries;

Ustilago species, such as, for example, Ustilago nuda or Ustilago avenae;

Pellicularia species, such as, for example, Pellicularia sasakii;

Pyricularia species, such as, for example, Pyricularia oryzae;

Fusarium species, such as, for example, Fusarium culmorum;

Botrytis species, such as, for example, Botrytis cinerea;

Septoria species, such as, for example, Septoria nodorum;

Leptosphaeria species, such as, for example, Leptosphaeria nodorum;

Cercospora species, such as, for example, Cercospora canescens;

Alternaria species, such as, for example, Alternaria brassicae; and

Pseudocercosporella species, such as, for example, Pseudocercosporella herpotrichoides,

Rhizoctonia species, such as, for example, Rhizoctonia solani.

The active compounds according to the invention also show a strong invigorating action in plants. Accordingly, they are suitable for mobilizing the internal defences of the plant against attack by unwanted microorganisms.

In the present context, plant-invigorating (resistance-inducing) compounds are to be understood as meaning substances which are capable of stimulating the defence system of plants such that, when the treated plants are subsequently inoculated with unwanted microorganisms, they display substantial resistance to these microorganisms.

In the present case, unwanted microorganisms are to be understood as meaning phytopathogenic fungi, bacteria and viruses. The compounds according to the invention can thus be used to protect plants within a certain period of time after treatment against attack by the pathogens mentioned. The period of time for which this protection is achieved generally extends for 1 to 10 days, preferably 1 to 7 days, from the treatment of the plants with the active compounds.

The fact that the active compounds are well tolerated by plants at the concentrations required for controlling plant diseases permits the treatment of above-ground parts of plants, of propagation stock and seeds, and of the soil.

The active compounds according to the invention can be used with particularly good results for controlling cereal diseases, such as, for example, against Puccinia species, and of diseases in viticulture and in the cultivation of fruits and vegetables, such as, for example, against Botrytis, Venturia and Alternaria species.

The active compounds according to the invention are also suitable for increasing the yield of crops. In addition, they show reduced toxicity and are well tolerated by plants.

If appropriate, the active compounds according to the invention can, at certain concentrations and application rates, also be employed as herbicides, for regulating plant growth and for controlling animal pests. If appropriate, they can also be used as intermediates or precursors in the synthesis of other active compounds.

According to the invention, it is possible to treat all plants and parts of plants. Plants are to be understood here as meaning all plants and plant populations, such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multilayer coating.

In the protection of materials, the compounds according to the invention can be employed for protecting industrial materials against infection with, and destruction by, unwanted microorganisms.

Industrial materials in the present context are understood as meaning non-living materials which have been prepared for use in industry. For example, industrial materials which are intended to be protected by active compounds according to the invention from microbial change or destruction can be tackifiers, sizes, paper and board, textiles, leather, wood, paints and plastic articles, cooling lubricants and other materials which can be infected with, or destroyed by, microorganisms. Parts of production plants, for example cooling-water circuits, which may be impaired by the proliferation of microorganisms may also be mentioned within the scope of the materials to be protected. Industrial materials which may be mentioned within the scope of the present invention are preferably tackifiers, sizes, paper and board, leather, wood, paints, cooling lubricants and heat-transfer liquids, particularly preferably wood.

Microorganisms capable of degrading or changing the industrial materials which may be mentioned are, for example, bacteria, fungi, yeasts, algae and slime organisms. The active compounds according to the invention preferably act against fungi, in particular moulds, wood-discolouring and wood-destroying fungi (Basidiomycetes) and against slime organisms and algae.

Microorganisms of the following genera may be mentioned as examples:

Alternaria, such as Alternaria tenuis,

Aspergillus, such as Aspergillus niger,

Chaetomium, such as Chaetomium globosum,

Coniophora, such as Coniophora puetana,

Lentinus, such as Lentinus tigrinus,

Penicillium, such as Penicillium glaucum,

Polyporus, such as Polyporus versicolor,

Aureobasidium, such as Aureobasidium pullulans,

Sclerophoma, such as Sclerophoma pityophila,

Trichoderma, such as Trichoderma viride,

Escherichia, such as Escherichia coli,

Pseudomonas, such as Pseudomonas aeruginosa, and

Staphylococcus, such as Staphylococcus aureus.

Depending on their particular physical and/or chemical properties, the active compounds can be converted into the customary formulations, such as solutions, emulsions, suspensions, powders, foams, pastes, granules, aerosols and microencapsulations in polymeric substances and in coating compositions for seeds, and ULV cool and warm fogging formulations.

These formulations are produced in a known manner, for example by mixing the active compounds with extenders, that is liquid solvents, liquefied gases under pressure, and/or solid carriers, optionally with the use of surfactants, that is emulsifiers and/or dispersants, and/or foam formers. If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, pumice, marble, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignosulphite waste liquors and methylcellulose.

Tackifiers such as carboxymethylcellulose, natural and synthetic polymers in the form of powders, granules or lattices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic, dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compound, preferably between 0.5 and 90%.

The active compounds according to the invention can, as such or in their formulations, also be used in a mixture with known fungicides, bactericides, acaricides, nematicides or insecticides, to broaden, for example, the activity spectrum or to prevent development of resistance. In many cases, synergistic effects are obtained, i.e. the activity of the mixture is greater than the activity of the individual components.

Suitable mixing components are, for example, the following compounds:

Fungicides:

2-phenylphenol; 8-hydroxyquinoline sulphate; acibenzolar-S-methyl; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; bilanafos; binapacryl; biphenyl; bitertanol; blasticidin-S; bromuconazole; bupirimate; buthiobate; butylamine; calcium polysulphide; capsimycin; captafol; captan; carbendazim; carboxin; carpropamid; carvone; chinomethionat; chlobenthiazone; chlorfenazole; chloroneb; chlorothalonil; chlozolinate; clozylacon; cyazofamid; cyflufenamid; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-M; dinocap; diphenylamine; dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; flurprimidol; flusilazole; flusulphamide; flutolanil; flutriafol; folpet; fosetyl-A1; fosetyl-sodium; fuberidazole; furalaxyl; furametpyr; furcarbanil; furmecyclox; guazatine; hexachlorobenzene; hexaconazole; hymexazole; imazalil; imibenconazole; iminoctadine triacetate; iminoctadine tris(albesil); iodocarb; ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M; metconazole; methasulphocarb; methfuroxam; metiram; metominostrobin; metsulphovax; mildiomycin; myclobutanil; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthiin; paclobutrazole; pefurazoate; penconazole; pencycuron; phosdiphen; phthalide; picoxystrobin; piperalin; polyoxins; polyoxorim; probenazole; prochloraz; procymidone; propamocarb; propanosine-sodium; propiconazole; propineb; proquinazid; prothioconazole; pyraclostrobin; pyrazophos; pyrifenox; pyrimethanil; pyroquilon; pyroxyfur; pyrrolenitrine; quinconazole; quinoxyfen; quintozene; simeconazole; spiroxamine; sulphur; tebuconazole; tecloftalam; tecnazene; tetcyclacis; tetraconazole; thiabendazole; thicyofen; thifluzamide; thiophanate-methyl; thiram; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin A; vinclozolin; zineb; ziram; zoxamide; (2S)—N-[2-[4-[[3-(4-chlorophenyl)-2-propynyl]oxy]-3-methoxyphenyl]ethyl]-3-methyl-2-[(methylsulphonyl)amino]butan-amide; 1-(1-naphthalenyl)-1H-pyrrole-2,5-dione; 2,3,5,6-tetrachloro-4-methylsulphonyl)pyridine; 2-amino-4-methyl-N-phenyl-5-thiazolecarboxamide; 2-chloro-N-(2,3-dihydro-1,1,3-trimethyl-1H-inden-4-yl)-3-pyridinecarboxamide; 3,4,5-trichloro-2,6-pyridinedicarbonitrile; actinovate; cis-1-(4-chlorophenyl)-2-(1H-1,2,4-triazol-1-yl)cycloheptanol; methyl 1-(2,3-dihydro-2,2-dimethyl-1H-inden-1-yl)-1H-imidazole-5-carboxylate; monopotassium carbonate; N-(6-methoxy3-pyridinyl)-cyclopropanecarboxamide; N-butyl-8-(1,1 dimethylethyl)-1-oxaspiro[4.5]decane-3-amine; sodium tetrathiocarbonate; and copper salts and preparations, such as Bordeaux mixture; copper hydroxide; copper naphthenate; copper oxychloride; copper sulphate; cufraneb; copper oxide; mancopper; oxine-copper.

Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

Insecticides/Acaricides/Nematicides:

abamectin, ABG-9008, acephate, acequinocyl, acetamiprid, acetoprole, acrinathrin, AKD-1022, AKD-3059, AKD-3088, alanycarb, aldicarb, aldoxycarb, allethrin, allethrin 1R-isomers, alpha-cypermethrin (alphamethrin), amidoflumet, aminocarb, amitraz, avermectin, AZ-60541, azadirachtin, azamethiphos, azinphos-methyl, azinphos-ethyl, azocyclotin, Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC-11821, baculoviruses, Beauveria bassiana, Beauveria tenella, benclothiaz, bendiocarb, benfuracarb, bensultap, benzoximate, beta-cyfluthrin, beta-cypermethrin, bifenazate, bifenthrin, binapacryl, bioallethrin, bioallethrin-S-cyclopentyl-isomer, bioethanomethrin, biopermethrin, bioresmethrin, bistrifluron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben, cadusafos, camphechlor, carbaryl, carbofuran, carbophenothion, carbosulphan, cartap, CGA-50439, chinomethionat, chlordane, chlordimeform, chloethocarb, chlorethoxyfos, chlorfenapyr, chlorfenvinphos, chlorfluazuron, chlormephos, chlorobenzilate, chloropicrin, chlorproxyfen, chlorpyrifos-methyl, chlorpyrifos (-ethyl), chlovaporthrin, chromafenozide, cis-cypermethrin, cis-resmethrin, cis-permethrin, clocythrin, cloethocarb, clofentezine, clothianidin, clothiazoben, codlemone, coumaphos, cyanofenphos, cyanophos, cycloprene, cycloprothrin, Cydia pomonella, cyfluthrin, cyhalothrin, cyhexatin, cypermethrin, cyphenothrin (1R-trans-isomer), cyromazine, DDT, deltamethrin, demeton-S-methyl, demeton-S-methylsulphone, diafenthiuron, dialifos, diazinon, dichlofenthion, dichlorvos, dicofol, dicrotophos, dicyclanil, diflubenzuron, dimefluthrin, dimethoate, dimethylvinphos, dinobuton, dinocap, dinotefuran, diofenolan, disulphoton, docusat-sodium, dofenapyn, DOWCO-439, eflusilanate, emamectin, emamectin-benzoate, empenthrin (1R-isomer), endosulphan, Entomopthora spp., EPN, esfenvalerate, ethiofencarb, ethiprole, ethion, ethoprophos, etofenprox, etoxazole, etrimfos, famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulphothion, fenthion, fentrifanil, fenvalerate, fipronil, flonicamid, fluacrypyrim, fluazuron, flubenzimine, flubrocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb, gamma-cyhalothrin, gamma-HCH, gossyplure, grandlure, granulosis viruses, halfenprox, halofenozide, HCH, HCN-801, heptenophos, hexaflumuron, hexythiazox, hydramethylnone, hydroprene, IKA-2002, imidacloprid, imiprothrin, indoxacarb, iodofenphos, iprobenfos, isazofos, isofenphos, isoprocarb, isoxathion, ivermectin, japonilure, kadethrin, nuclear polyhedrosis viruses, kinoprene, lambda-cyhalothrin, lindane, lufenuron, malathion, mecarbam, mesulphenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metofluthrin, metolcarb, metoxadiazone, mevinphos, milbemectin, milbemycin, MKI-245, MON-45700, monocrotophos, moxidectin, MTI-800, naled, NC-104, NC-170, NC-184, NC-194, NC-196, niclosamide, nicotine, nitenpyram, nithiazine, NNI-0001, NNI-0101, NNI-0250, NNI-9768, novaluron, noviflumuron, OK-5101, OK-5201, OK-9601, OK-9602, OK-9701, OK-9802, omethoate, oxamyl, oxydemeton-methyl, Paecilomyces fumosoroseus, parathion-methyl, parathion (-ethyl), permethrin (cis-, trans-), petroleum, PH-6045, phenothrin (1R-trans isomer), phenthoate, phorate, phosalone, phosmet, phosphamidon, phosphocarb, phoxim, piperonyl butoxide, pirimicarb, pirimiphos-methyl, pirimiphos-ethyl, potassium oleate, prallethrin, profenofos, profluthrin, promecarb, propaphos, propargite, propetamphos, propoxur, prothiofos, prothoate, protrifenbute, pymetrozine, pyraclofos, pyresmethrin, pyrethrum, pyridaben, pyridalyl, pyridaphenthion, pyridathion, pyrimidifen, pyriproxyfen, quinalphos, resmethrin, RH-5849, ribavirin, RU-12457, RU-15525, S421, S-1833, salithion, sebufos, SI-0009, silafluofen, spinosad, spirodiclofen, spiromesifen, sulphluramid, sulphotep, sulprofos, SZI-121, tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (1R-isomer), tetrasul, theta-cypermethrin, thiacloprid, thiamethoxam, thiapronil, thiatriphos, thiocyclam hydrogenoxalate, thiodicarb, thiofanox, thiometon, thiosultap-sodium, thuringiensin, tolfenpyrad, tralocythrin, tralomethrin, transfluthrin, triarathene, triazamate, triazophos, triazuron, trichlophenidine, trichlorfon, Trichoderma atroviride, triflumuron, trimethacarb, vamidothion, vaniliprole, verbutin, Verticillium lecanii, WL-108477, WL-40027, YI-5201, YI-5301, YI-5302, XMC, xylylcarb, ZA-3274, zeta-cypermethrin, zolaprofos, ZXI-8901, the compound 3-methylphenyl propylcarbamate (Tsumacide Z), the compound 3-(5-chloro-3-pyridinyl)-8-(2,2,2-trifluoroethyl)-8-azabicyclo[3.2.1]octane-3-carbonitrile (CAS-Reg. No. 185982-80-3) and the corresponding 3-endo-isomer (CAS-Reg. No. 185984-60-5) (cf. WO-96/37494, WO-98/25923), and preparations which comprise insecticidally active plant extracts, nematodes, fungi or viruses.

A mixture with other known active compounds, such as herbicides, or with fertilizers and growth regulators, safeners and/or semiochemicals is also possible.

In addition, the compounds of the formula (I) according to the invention also have very good antimycotic activity. They have a very broad antimycotic activity spectrum in particular against dermatophytes and yeasts, moulds and diphasic fungi (for example against Candida species such as Candida albicans, Candida glabrata) and Epidermophyton floccosum, Aspergillus species such as Aspergillus niger and Aspergillus fumigatus, Trichophyton species such as Trichophyton mentagrophytes, Microsporon species such as Microsporon canis and audouinii. The list of these fungi does by no means limit the mycotic spectrum which can be covered, but is only for illustration.

The active compounds can be used as such, in the form of their formulations or the use forms prepared therefrom, such as ready-to-use solutions, suspensions, wettable powders, pastes, soluble powders, dusts and granules. Application is carried out in a customary manner, for example by watering, spraying, atomizing, broadcasting, dusting, foaming, spreading, etc. It is furthermore possible to apply the active compounds by the ultra-low volume method, or to inject the active compound preparation or the active compound itself into the soil. It is also possible to treat the seeds of the plants.

When using the active compounds according to the invention as fungicides, the application rates can be varied within a relatively wide range, depending on the kind of application. For the treatment of parts of plants, the active compound application rates are generally between 0.1 and 10 000 g/ha, preferably between 10 and 1000 g/ha. For seed dressing, the active compound application rates are generally between 0.001 and 50 g per kilogram of seed, preferably between 0.01 and 10 g per kilogram of seed. For the treatment of the soil, the active compound application rates are generally between 0.1 and 10 000 g/ha, preferably between 1 and 5 000 g/ha.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof, are treated. The term “parts” or “parts of plants” or “plant parts” has been explained above.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or by recombinant DNA techniques. They can be cultivars, varieties, bio- or genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are emphasized are in particular increased defence of the plants against insects, arachnids, nematodes and slugs and snails by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are also particularly emphasized are the increased defence of the plants against fungi, bacteria and viruses by systemic acquired resistance (SAR), system, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucoton® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned also include the varieties sold under the name Clearfield® (for example maize). Of course, these statements also apply to plant cultivars which have these genetic traits or genetic traits still to be developed, and which will be developed and/or marketed in the future.

The plants listed can be treated according to the invention in a particularly advantageous manner with the compounds of the general formula (I) or the active compound mixtures according to the invention. The preferred ranges stated above for the active compounds or mixtures also apply to the treatment of these plants. Particular emphasis is given to the treatment of plants with the compounds or mixtures specifically mentioned in the present text.

The preparation and the use of the active compounds according to the invention is illustrated by the examples below.

### PREPARATION EXAMPLES

### Example 1

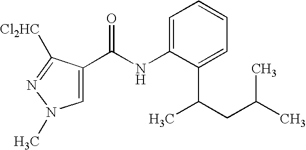

177.3 mg (1.0 mmol) of 2-(1,3-dimethylbutyl)phenylamine are added to a solution comprising 250.2 mg (1.1 mmol) of 3-dichloromethyl-1-methyl-1H-pyrazole-4-carbonyl chloride and 161.9 mg (1.6 mmol) of triethylamine in 10 ml of tetrahydrofuran. The reaction mixture is stirred at 60° C. for 16 h, filtered through silica gel and concentrated under reduced pressure.

Column chromatography (cyclohexane/ethyl acetate 3:1) gives 257.6 mg (70% of theory) of 3-(dichloromethyl)-1-methyl-N-[2-(1,3-dimethylbutyl)phenyl]-1H-pyrazole-4-carboxamide [logP (pH 2.3)=3.74].

### Example 2

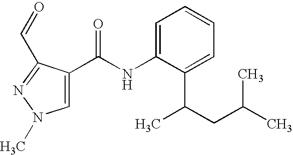

135.9 mg (1.07 mmol) of oxalyl chloride and a few drops of dimethylformamide are added to a suspension comprising 150.0 mg (0.97 mmol) of 3-formyl-1-methyl-1H-pyrazole-4-carboxylic acid in 7 ml of dichloromethane. After 2 h at room temperature, a solution comprising 172.5 mg (0.97 mmol) of 2-1,3-dimethylbutyl)phenylamine in 7 ml of dichloromethane and 128.0 mg (1.27 mmol) of triethylamine is added dropwise. After 16 h at room temperature, 7 ml of 2N hydrochloric acid are added and the organic phase is separated off, dried over magnesium sulphate and filtered through silica gel.

Concentration under reduced pressure gives 273.6 mg (90% of theory) of N-[2-(1,3-dimethylbutyl)phenyl]-3-formyl-1-methyl-1H-pyrazole-4-carboxamide [log P (pH 2.3)=3.64].

### Example 3

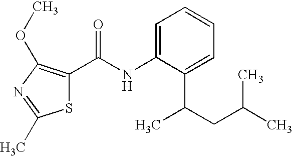

350 mg (1.83 mmol) of 4-methoxy-2-methyl-1,3-thiazole-5-carbonyl chloride and 324 mg (1.83 mmol) of [2-1,3-dimethylbutyl)phenyl]amine in 40 ml of acetonitrile were stirred in a closed vessel under argon at room temperature for 20 h and at 50° C. for 8 h. 20 ml of water and 40 ml of ethyl acetate were then added, and the organic phase was separated off, washed with 30 ml of saturated ammonium chloride solution and water, dried over sodium sulphate and concentrated.

Column-chromatographic purification on silica gel 60 (petroleum ether/ethyl acetate 5:1→ethyl acetate) gave 420 mg of N-[2-(1,3-dimethylbutyl)phenyl]-4-methoxy-2-methyl-1,3-thiazole-5-carboxamide [logP (pH 2.3)=4.45].

### Example 4

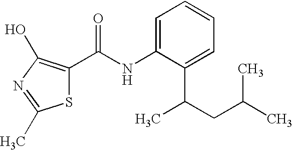

170 mg (0.38 mmol) of N-[2-(1,3-dimethylbutyl)phenyl]-4-methoxy-2-methyl-1,3-thiazole-5-carboxamide (Example 3) and 60 mg of anhydrous aluminium chloride in 8 ml of 1,2-dichloroethane were stirred at 40-50° C. for 24 h. 10 ml of water were then added, the organic phase was removed and the aqueous phase was extracted two more times with in each case 30 ml of dichloromethane. The combined organic phases were dried over sodium sulphate and concentrated.

Column-chromatographic purification on silica gel 60 (dichloromethane/diethyl ether 5:1) gave 60 mg of N-[2-(1,3-dimethylbutyl)phenyl]-4-hydroxy-2-methyl-1,3-thiazole-5-carboxamide [logP (pH 2.3)=2.68].

The compounds of the formula (I) listed in Table I below are obtained analogously to Examples 1 to 4 and in accordance with the instructions in the general descriptions of the processes.

TABLE 1

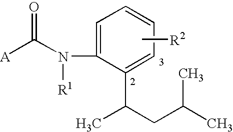

| Ex. | R¹ | R² | A | logP |
|---|---|---|---|---|
| 5 | H | H | 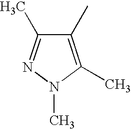 | 2.99 |
| 6 | H | H | 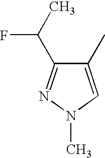 | 3.34 |
| 7 | H | H | 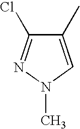 | 3.49 |
| 8 | H | H | 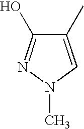 | 2.46 |
| 9 | H | H | 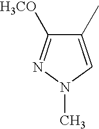 | 3.48 |
| 10 | H | H | 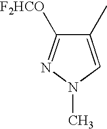 | 3.91 |
| 11 | H | H | 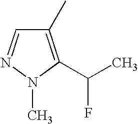 | 3.51 |
| 12 | H | 4-F | 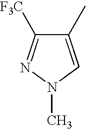 | 3.60 |
| 13 | H | 4-F | 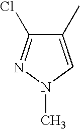 | 3.49 |
| 14 | H | 4-F | 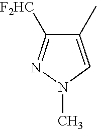 | 3.35 |
| 15 | H | H | 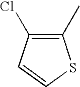 | 4.63 |
| 16 | H | H | 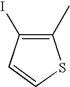 | 4.51 |
| 17 | H | 4-F | 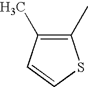 | 4.11 |
| 18 | H | H | 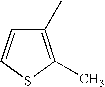 | 4.09 |
| 19 | H | 4-F | 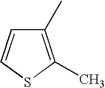 | 4.08 |
| 20 | H | 4-F | 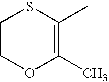 | 3.99 |
| 21 | H | H | 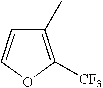 | 4.10 |
| 22 | H | 4-F | 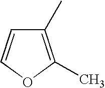 | 3.81 |
| 23 | H | H | 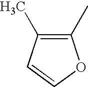 | 4.20 |
| 24 | H | H | 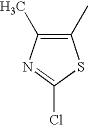 | 4.21 |
| 25 | H | H | 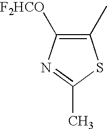 | 4.75 |
| 26 | H | H | 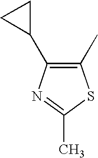 | 4.17 |
| 27 | H | 4-F | 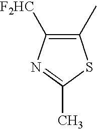 | 3.72 |
| 28 | H | 4-F | 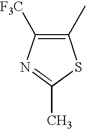 | 4.04 |
| 29 | H | H | 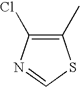 | 3.86 |
| 30 | H | H | 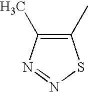 | 3.54 |
| 31 | H | H | 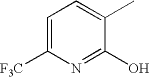 | 3.74 |
| 32 | H | H | 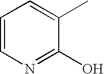 | 2.80 |
| 33 | H | H | 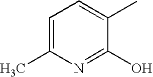 | 2.94 |
| 34 | H | H | 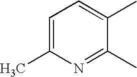 | 3.35 |
| 35 | H | H | 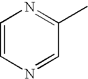 | 3.68 |
| 36 | H | 4-F | 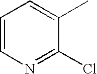 | 3.35 |
| 37 | H | H | 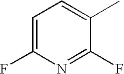 | b.p. 76-81 ° C. |
| 38 | H | H | 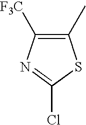 | 4.54 |

Preparation of Starting Materials of the Formula (II)

### Example (II-1)

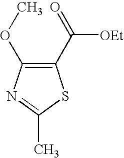

200 mg (1.07 mmol) of ethyl 4-hydroxy-2-methyl-1,3-thiazole-5-carboxylate and 100 mg of silica gel were initially charged in 10 ml of dichloromethane, 0.9 ml (1.3 mmol) of trimethylsilyldiazomethane (2N in hexane) were added using a syringe and the mixture was stirred at room temperature for 3 days. Subsequently, 1 ml of methanol and then 5 ml of water were added. The organic phase was separated off and the aqueous phase was extracted two more times with dichloromethane. The combined organic phases were washed twice with in each case 20 ml of water, dried over sodium sulphate and concentrated. This gave 196 mg (91% of theory) of ethyl 4-methoxy-2-methylthiazole-5-carboxylate [logP (pH 2.3)=1.90].

### Example (II-2)

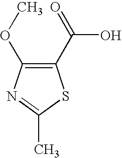

210 mg (1.0 mmol) of ethyl 4-methoxy-2-methylthiazole-5-carboxylate were initially charged in 5 ml of ethanol, and 123 mg (2.2 mmol) of potassium hydroxide, dissolved in 1 ml of water, were added. After 4 h of stirring at room temperature and 30 h of stirring under reflux, the mixture was concentrated. The residue was taken up in 30 ml of water and extracted twice with 30 ml of diethyl ether. The aqueous phase was acidified with dilute hydrochloric acid and again extracted three times with in each case 30 ml of ethyl acetate. The combined org. extracts were dried over sodium sulphate and concentrated. This gave 185 mg (quantitative) of 4-methoxy-2-methylthiazole-5-carboxylic acid [logP (pH 2.3)=0.77].

### Example (II-3)

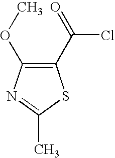

3.35 g (19.3 mmol) of 4-methoxy-2-methyl-1,3-thiazole-5-carboxylic acid and 11.5 g of thionyl chloride in 30 ml of toluene was stirred at 85° C. for 3 h. The mixture was concentrated, and in each case 10 ml of dichloromethane were added three times to the residue and the mixture was concentrated. This gave 3.3 g (89% of theory) of 4-methoxy-2-methylthiazole-5-carbonyl chloride [analysed using the methyl ether: logP (pH 2.3)=1.45].

### Example (II-4)

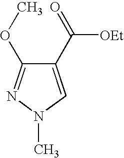

2.60 g (15.3 mmol) of ethyl 3-hydroxy-1-methyl-1H-pyrazole-4-carboxylate and 0.43 g of silica gel were initially charged in 140 ml of dichloromethane, 12.7 ml (18.3 mmol) of trimethylsilyldiazomethane (2N in hexane) were added using a syringe and the mixture was stirred at room temperature for 2 days. Another 2 ml of trimethylsilyldiazomethane were added, and the mixture was stirred at room temperature for another 24 h. 1 ml of methanol and then 100 ml of water were subsequently added, the organic phase was separated off and the aqueous phase was extracted two more times with in each case 40 ml of dichloromethane. The combined organic phases were dried over sodium sulphate and concentrated. Column-chromatographic purification on silica gel 60 using ethyl acetate/hexane 3:1 gave 1.4 g (50% of theory) of ethyl 3-methoxy-1-methyl-1H-pyrazole-4-carboxylate [logP (pH 2.3)=1.14].

### Example (II-5)

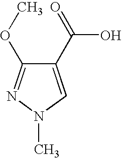

4.6 g (27.0 mmol) of methyl 3-methoxy-1-methyl-1H-pyrazole-4-carboxylate were initially charged in 40 ml of ethanol, and 3.19 g (56.8 mmol) of potassium hydroxide, dissolved in 10 ml of water, were added. After 18 h of stirring at room temperature and 4 h of stirring at 40° C., the mixture was concentrated, the residue was taken up in 50 ml of water and the mixture was extracted twice with in each case 30 ml of diethyl ether. The aqueous phase was acidified with hydrochloric acid and again extracted three times with in each case 30 ml of ethyl acetate. The combined organic extracts were dried over sodium sulphate and concentrated. This gave 3.9 g (92% of theory) of 3-methoxy-1-methyl-1H-pyrazole-4-carboxylic acid.

### Example (II-6)

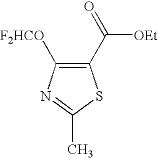

5.0 g (26.7 mmol) of ethyl 4-hydroxy-2-methyl-1,3-thiazole-5-carboxylate and 7.4 g of potassium carbonate were initially charged in 30 ml of dimethylformamide, and the mixture was heated at 100° C. 2.3 g (26.7 mmol) of Frigen were introduced over a period of 3 h. After cooling, the mixture was concentrated, 100 ml of water/ethyl acetate were added to the residue, and the organic phase was separated off and washed three more times with water. The organic phase was dried over sodium sulphate and concentrated. This gave 5.6 g (88% of theory) of ethyl 4-(difluoromethoxy)-2-methyl-1,3-thiazole-5-carboxylate [logP (pH 2.3)=2.54].

### Example (II-7)

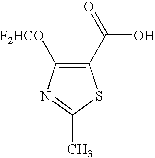

5.5 g (23.2 mmol) of ethyl 4-(difluoromethoxy)-2-methyl-1,3-thiazole-5-carboxylate were initially charged in 40 ml of ethanol, and 1.4 g (25.5 mmol) of potassium hydroxide, dissolved in 10 ml of water, were added. After 16 h of stirring at room temperature, the mixture was concentrated, the residue was taken up in 80 ml of water and extracted twice with in each case 40 ml of ethyl acetate and the aqueous phase was acidified with hydrochloric acid and again extracted three times with in each case 60 ml of ethyl acetate. The combined-organic extracts were dried over sodium sulphate and concentrated.

This gave 3.9 g (80% of theory) of 4-(difluoromethoxy)-2-methyl-1,3-thiazole-5-carboxylic acid [logP (pH 2.3)=1.29].

### Example (II-8)

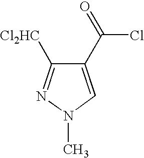

300 mg (1.9 mmol) of 3-formyl-1-methyl-1H-pyrazole-4-carboxylic acid are dissolved in 60 ml of dichloromethane, and 1.0 g (4.9 mmol) of phosphorus pentachloride is added. After 1.5 h at room temperature, the mixture is poured onto ice-water and extracted with dichloromethane, and the extract is dried over magnesium sulphate, filtered and concentrated under reduced pressure. This gives 384 mg (86% of theory) of 3-dichloromethyl-1-methyl-1H-pyrazole-4-carbonyl chloride.

Preparation of Starting Materials of the Formula (VII)

### Example (VII-1)

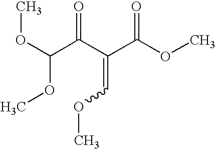

16.0 ml (170 mol) of acetic anhydride are added to a solution comprising 10.0 g (57 mmol) of methyl 4,4-dimethoxy-3-oxobutyrate in 9.0 g (85 mmol) or trimethyl orthoformate. The reaction mixture is heated under reflux for 16 h.

Distillation of the reaction mixture (boiling point 132-135° C., 0.2 bar) gives 7.0 g (56% of theory) of methyl 4,4-dimethoxy-2-methoxymethylene-3-oxobutyrate.

Preparation of Starting Materials of the Formula (IX)

### Example (IX-1)

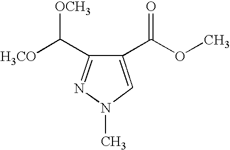

At −5° C., a solution comprising 2.0 ml (38 mmol) of methylhydrazine in 340 ml of methanol is slowly added dropwise to 7.5 g of methyl 4,4-dimethoxy-2-methoxymethylene-3-oxobutyrate. After the addition is ended, the reaction mixture is stirred at room temperature for 16 h and concentrated under reduced pressure.

Column chromatography (mobile phase gradient cyclohexane/ethyl acetate) gives 6.5 g (77% of theory) of methyl 3-dimethoxymethyl-1-methyl-1H-pyrazole-4-carboxylate.

Preparation of Starting Materials of the Formula (X)

### Example (X-1)

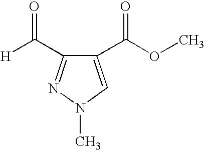

10 ml of concentrated hydrochloric acid are added to a solution of 2.1 g (10 mmol) methyl of 3-dimethoxymethyl-1-methyl-1H-pyrazole-4-carboxylate in 20 ml of dioxane, and the mixture is stirred at room temperature for 16 h. For work-up, the mixture is concentrated under reduced pressure, the residue is taken up in 200 ml of methylene chloride and the mixture is washed with 50 ml of water. The organic phase is dried over magnesium sulphate, filtered and concentrated. This gives 1.6 g (94% of theory) of methyl 3-formyl-1-methyl-1H-pyrazole-4-carboxylate [logP (pH 2.3)=0.46].

Preparation of Starting Materials of the Formula (XI)

### Example (XI-1)

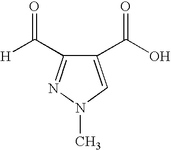

6.0 g (35.68 mmol) of methyl 3-formyl-1-methyl-1H-pyrazole-4-carboxylate are dissolved in 180 ml of tetrahydrofuran and 90 ml of water, and 0.94 g (39.25 mmol) of lithium hydroxide is added. The reaction mixture is stirred at room temperature for 16 h, the organic solvent is removed under reduced pressure and the aqueous phase that remains is acidified with dilute hydrochloric acid and extracted three times with in each case 100 ml of ethyl acetate. The organic phases are dried over magnesium sulphate, filtered and concentrated. This gives 4.28 g (78% of theory) of 3-formyl-1-methyl-1H-pyrazole-4-carboxylic acid of logP (pH=2.3)=−0.19.

Preparation of Starting Materials of the Formula (XII)

### Example (XII-1)

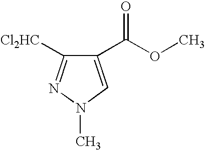

46.1 mg (0.27 mmol) of methyl 3-formyl-1-methyl-1H-pyrazole-4-carboxylate are dissolved in 10 ml of dichloromethane, and 142.9 mg (0.67 mmol) of phosphorus pentachloride are added. The reaction mixture is stirred at room temperature for 1.5 h, poured into water and extracted with diethyl ether, and the extract is dried over magnesium sulphate and concentrated under reduced pressure. This gives 53.0 mg (86% of theory) of methyl 3-(dichloromethyl)-1-methyl-1H-pyrazole-4-carboxylate of logP (pH 2.3)=1.80.

This methyl ester can be hydrolysed in a customary manner. This gives 3-(dichloromethyl)-1-methyl-1H-pyrazole-4-carboxylic acid which is either coupled directly with compounds of the formula (III) or first converted into the acid chloride.

The logP values given in the Preparation Examples and tables above are determined in accordance with EEC Directive 79/831 Annex V.A8 by HPLC (High Performance Liquid Chromatography) on a reversed-phase column (C 18). Temperature: 43° C.

The determination is carried out in the acidic range at pH 2.3 using the mobile phases 0.1% aqueous phosphoric acid and acetonitrile; linear gradient from 10% acetonitrile to 90% acetonitrile.

Calibration is carried out using unbranched alkan-2-ones (with 3 to 16 carbon atoms) with known logP values (determination of the logP values by the retention times using linear interpolation between two successive alkanones).

The lambda max values were determined in the maxima of the chromatographic signals using the UV spectra from 200 nm to 400 nm.

### Use Examples

### Example A

Podosphaera Test (Apple)/Protective

Solvents: 24.5 parts by weight of acetone
24.5 parts by weight of dimethylacetamide
Emulsifier: 1 part by weight of alklylaryl polyglycol ether

To produce a suitable preparation of active compound, 1 part by weight of active compound is mixed with the stated amounts of solvents and emulsifier, and the concentrate is diluted with water to the desired concentration.

To test for protective activity, young plants are sprayed with the preparation of active compound at the stated application rate. After the spray coating has dried on, the plants are inoculated with an aqueous spore suspension of the apple mildew pathogen Podosphaera leucotricha. The plants are then placed in a greenhouse at about 23° C. and a relative atmospheric humidity of about 70%.

Evaluation is carried out 10 days after the inoculation. 0% means an efficacy which corresponds to that of the control, whereas an efficacy of 100% means that no infection is observed.

TABLE A
Podosphaera test (apple)/protective

| | Application rate of | |
|---|---|---|
| Active compound | active compound in | |
| according to the invention | g/ha | Efficacy in % |
| 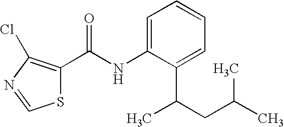 | 100 | 100 |
| 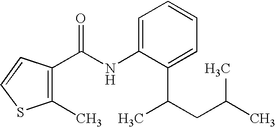 | 100 | 100 |
| 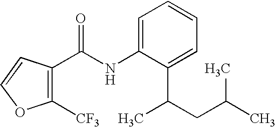 | 100 | 98 |
| 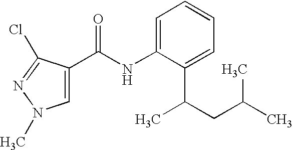 | 100 | 100 |
| 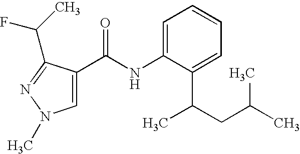 | 100 | 100 |
| 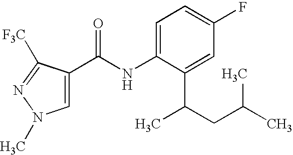 | 100 | 88 |
| 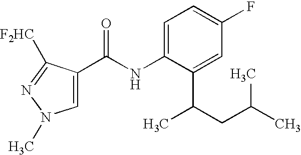 | 100 | 100 |
| 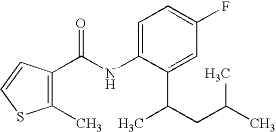 | 100 | 100 |
| 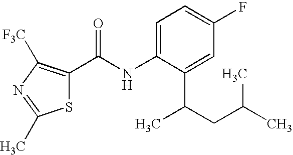 | 100 | 100 |
| 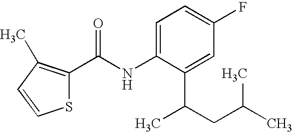 | 100 | 99 |
| 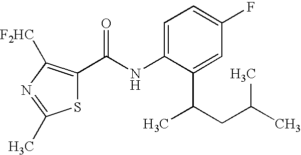 | 100 | 100 |
| 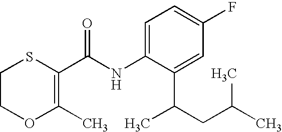 | 100 | 100 |

### Example B

Venturia Test (Apple)/Protective

Solvents: 24.5 parts by weight of acetone
24.5 parts by weight of dimethylacetamide
Emulsifier: 1 part by weight of alkylaryl polyglycol ether

To produce a suitable preparation of active compound, 1 part by weight of active compound is mixed with the stated amounts of solvents and emulsifier, and the concentrate is diluted with water to the desired concentration.

To test for protective activity, young plants are sprayed with the preparation of active compound at the stated application rates. After the spray coating has dried on, the plants are inoculated with an aqueous conidia suspension of the apple scab pathogen Venturia inaequalis and then remain in an incubation cabinet about 20° C. and 100% relative atmospheric humidity for 1 day.

The plants are then placed in a greenhouse at about 21° C. and a relative atmospheric humidity of about 90%.

Evaluation is carried out 10 days after the inoculation. 0% means an efficacy which corresponds to that of the control, whereas an efficacy of 100% means that no infection is observed.

TABLE B
Venturia test (apple)/protective

| | Application rate of | |
|---|---|---|
| Active compound | active compound in | |
| according to the invention | g/ha | Efficacy in % |
| 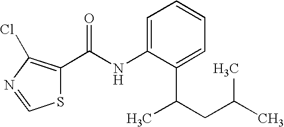 | 100 | 99 |
| 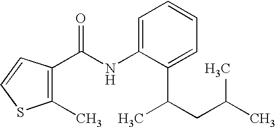 | 100 | 100 |
| 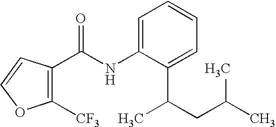 | 100 | 96 |
| 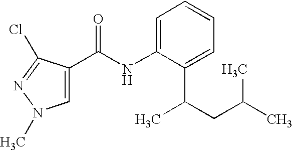 | 100 | 100 |
| 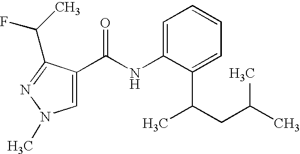 | 100 | 100 |
| 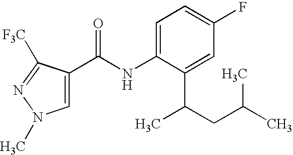 | 100 | 100 |
| 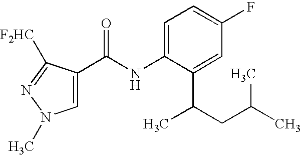 | 100 | 100 |
| 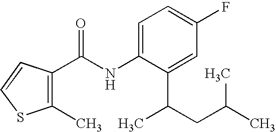 | 100 | 94 |
| 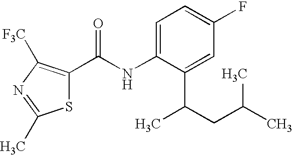 | 100 | 100 |
| 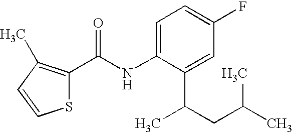 | 100 | 100 |
| 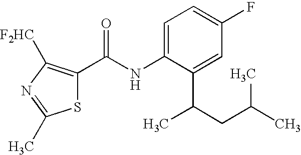 | 100 | 100 |
| 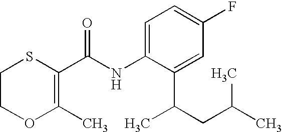 | 100 | 100 |

### Example C

Botrytis Test (Bean)/Protective

Solvents: 24.5 parts by weight of acetone
24.5 parts by weight of dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated application rate. After the spray coating has dried on, 2 small pieces of agar colonized by Botrytis cinerea are placed under each leaf. The inoculated plants are placed in a dark chamber at about 20° C. and 100% relative atmospheric humidity.

Two days after the inoculation, the size of the infected areas on the leaves is evaluated. 0% means an efficacy which corresponds to that of the control, whereas an efficacy of 100% means that no infection is observed.

TABLE C
Botrytis test (bean)/protective

| | Application rate of | |
|---|---|---|
| Active compound | active compound in | |
| according to the invention | g/ha | Efficacy in % |
| 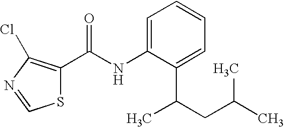 | 100 | 99 |
| 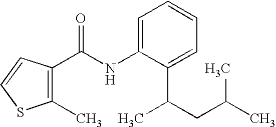 | 100 | 97 |
| 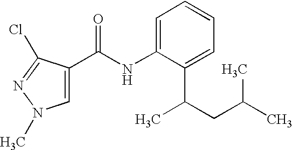 | 100 | 100 |
| 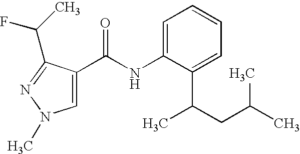 | 500 | 99 |
| 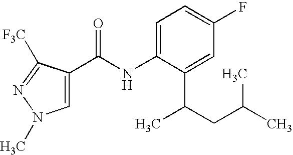 | 500 | 99 |
| 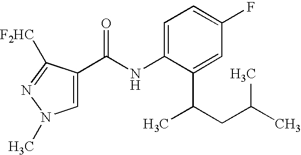 | 500 | 100 |
| 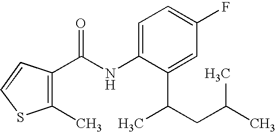 | 500 | 100 |
| 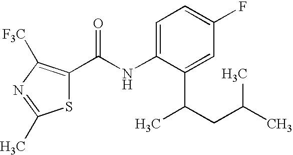 | 500 | 100 |
| 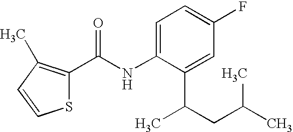 | 500 | 98 |
| 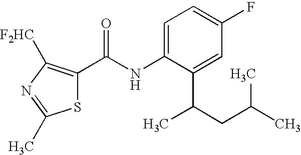 | 500 | 100 |
| 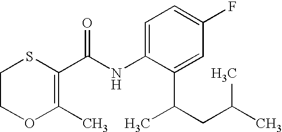 | 500 | 100 |

### Example D

Puccinia Test (Wheat)/Protective

Solvent: 50 parts by weight of N,N-dimethylacetamide

Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated application rate. After the spray coating has dried on, the plants are sprayed with a conidia suspension of Puccinia recondita. The plants remain in an incubation cabinet at 20° C. and 100% relative atmospheric humidity for 48 hours.

The plants are then placed in a greenhouse at a temperature of about 20° C. and a relative atmospheric humidity of 80% to promote the development of rust pustules.

Evaluation is carried out 10 days after the inoculation. 0% means an efficacy which corresponds to that of the control, whereas an efficacy of 100% means that no infection is observed.

TABLE D
Puccinia test (wheat)/protective

| | Application rate of | |
|---|---|---|
| Active compound | active compound in | |
| according to the invention | g/ha | Efficacy in % |
| 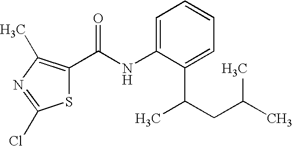 | 500 | 100 |
| 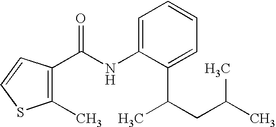 | 500 | 100 |
| 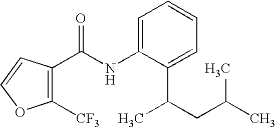 | 500 | 100 |
| 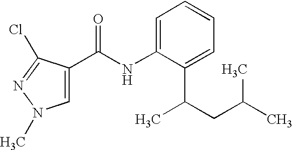 | 500 | 100 |
| 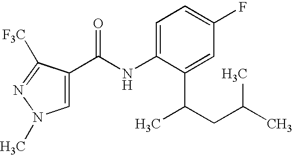 | 500 | 100 |
| 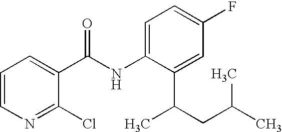 | 500 | 100 |
| 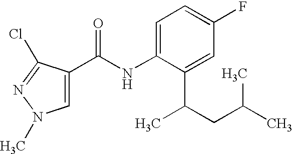 | 500 | 100 |
| 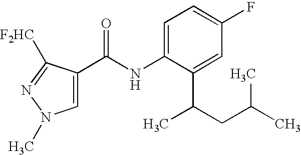 | 500 | 100 |
| 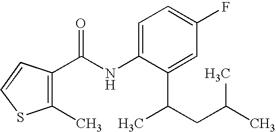 | 500 | 100 |
| 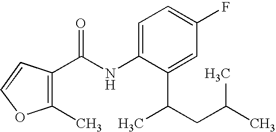 | 500 | 100 |
| 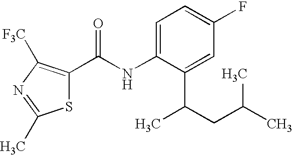 | 500 | 100 |
| 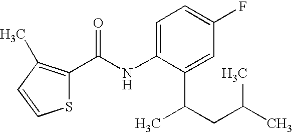 | 500 | 100 |
| 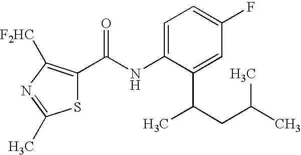 | 500 | 100 |
| 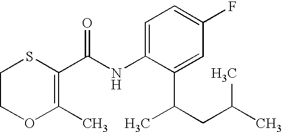 | 500 | 100 |

### Example E

Sphaerotheca Test (Cucumber)/Protective

Solvent: 49 parts by weight of N,N-dimethylformamide

Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young cucumber plants are sprayed with the preparation of active compound at the stated application rate. One day after the treatment, the plants are inoculated with a spore suspension of Sphaerotheca fuliginea. The plants are then placed in a greenhouse at 70% relative atmospheric humidity and a temperature of 23° C.

Evaluation is carried out 7 days after the inoculation. 0% means an efficacy which corresponds to that of the control, whereas an efficacy of 100% means that no infection is observed.

TABLE E
Sphaerotheca test (cucumber)/protective

| | Application rate of | |
|---|---|---|
| Active compound | active compound in | |
| according to the invention | g/ha | Efficacy in % |
| 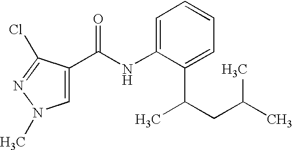 | 750 | 100 |
| 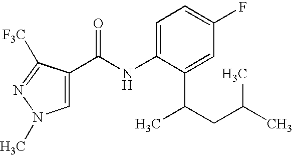 | 750 | 100 |
| 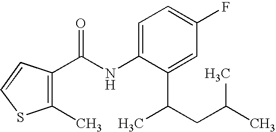 | 750 | 100 |

What is claimed is:

1-10. (canceled)

11. A 1,3-dimethylbutylcarboxanilide of formula (I) 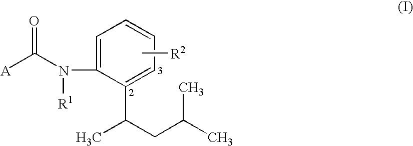
in which
R¹ represents hydrogen, C₁-C₈-alkyl, C₁-C₆-alkylsulphinyl, C₁-C₆-alkylsulphonyl, C₁-C₄-alkoxy-C₁-C₄-alkyl, or C₃-C₈-cycloalkyl; represents C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, or C₃-C₈-halocycloalkyl having in each case 1 to 9 fluorine, chlorine, and/or bromine atoms; represents formyl, formyl-C₁-C₃-alkyl, (C₁-C₃-alkyl)carbonyl-C₁-C₃-alkyl, or (C₁-C₃-alkoxy)carbonyl-C₁-C₃-alkyl; represents halo-(C₁-C₃-alkyl)carbonyl-C₁-C₃-alkyl or halo-(C₁-C₃-alkoxy)-carbonyl-C₁-C₃-alkyl having in each case 1 to 13 fluorine, chlorine and/or bromine atoms; represents (C₁-C₈-alkyl)carbonyl, (C₁-C₈-alkoxy)carbonyl, (C₁-C₄-alkoxy-C₁-C₄-alkyl)carbonyl, or (C₃-C₈-cycloalkyl)carbonyl; represents (C₁-C₆-haloalkyl)carbonyl, (C₁-C₆-haloalkoxy)carbonyl, (halo-C₁-C₄-alkoxy-C₁-C₄-alkyl)carbonyl, or (C₃-C₈-halocycloalkyl)carbonyl having in each case 1 to 9 fluorine, chlorine, and/or bromine atoms; or represents —C(═O)C(═O)R³, —CONR⁴R⁵, or —CH₂NR⁶R⁷,
R² represents hydrogen, fluorine, chlorine, methyl, or trifluoromethyl,
R³ represents hydrogen, C₁-C₈-alkyl, C₁-C₈-alkoxy, C₁-C₄-alkoxy-C₁-C₄-alkyl, or C₃-C₈-cycloalkyl; represents C₁-C₆-haloalkyl, C₁-C₆-haloalkoxy, halo-C₁-C₄-alkoxy-C₁-C₄-alkyl, or C₃-C₈-halocycloalkyl having in each case 1 to 9 fluorine, chlorine, and/or bromine atoms,
R⁴ and R⁵ independently of one another each represent hydrogen, C₁-C₈-alkyl, C₁-C₄-alkoxy-C₁-C₄-alkyl, or C₃-C₈-cycloalkyl; represent C₁-C₈-haloalkyl, halo-C₁-C₄-alkoxy-C₁-C₄-alkyl, or C₃-C₈-halocycloalkyl having in each case 1 to 9 fluorine, chlorine, and/or bromine atoms; or R⁴ and R⁵ together with the nitrogen atom to which they are attached form a saturated heterocycle having 5 to 8 ring atoms that is optionally mono- or polysubstituted by identical or different substituents selected from the group consisting of halogen and C₁-C₄-alkyl, where the heterocycle optionally contains 1 or 2 further non-adjacent heteroatoms selected from the group consisting of oxygen, sulphur, and NR⁸,
R⁶ and R⁷ independently of one another represent hydrogen, C₁-C₈-alkyl, or C₃-C₈-cycloalkyl; or represent C₁-C₈-haloalkyl or C₃-C₈-halocycloalkyl having in each case 1 to 9 fluorine, chlorine, and/or bromine atoms; or R⁶ and R⁷ together with the nitrogen atom to which they are attached form a saturated heterocycle having 5 to 8 ring atoms that is optionally mono- or poly-substituted by identical or different substituents selected from the group consisting of halogen and C₁-C₄-alkyl, where the heterocycle optionally contains 1 or 2 further non-adjacent heteroatoms selected from the group consisting of oxygen, sulphur, and NR⁸,
R⁸ represents hydrogen or C₁-C₆-alkyl, and
A represents
(1) a radical of formula (A1) 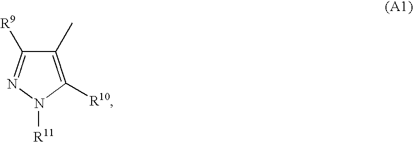
in which
R⁹ represents hydrogen, hydroxyl, formyl, cyano, fluorine, chlorine, bromine, nitro, C₁-C₄-alkyl, C₁-C₄-alkoxy, C₁-C₄-alkylthio, or C₃-C₆-cycloalkyl; represents C₁-C₄-haloalkyl, C₁-C₄-haloalkoxy, C₁-C₄-haloalkylthio having in each case 1 to 5 halogen atoms; or represents aminocarbonyl or aminocarbonyl-C₁-C₄-alkyl,
R¹⁰ represents hydrogen, chlorine, bromine, iodine, cyano, C₁-C₄-alkyl, C₁-C₄-alkoxy, C₁-C₄-alkylthio, or C₁-C₄-haloalkyl having 1 to 5 halogen atoms, and
R¹¹ represents hydrogen, C₁-C₄-alkyl, hydroxyl-C₁-C₄-alkyl, C₂-C₆-alkenyl, C₃-C₆-cycloalkyl, C₁-C₄-alkylthio-C₁-C₄-alkyl, or C₁-C₄-alkoxy-C₁-C₄-alkyl; or represents C₁-C₄-haloalkyl, C₁-C₄-haloalkylthio-C₁-C₄-alkyl, or C₁-C₄-haloalkoxy-C₁-C₄-alkyl having in each case 1 to 5 halogen atoms; or represents phenyl,
with the provisos that
(a) R⁹ does not represent trifluoromethyl, difluoromethyl, methyl, or ethyl if R¹⁰ represents hydrogen or chlorine, R¹¹ represents methyl, and R¹ and R² simultaneously represent hydrogen, and
(b) R⁹ does not represent methyl, difluorochloromethyl, trifluoromethyl, difluoromethyl, chlorine or bromine if R¹⁰ represents hydrogen, fluorine, trifluoromethyl, or methyl, R¹¹ represents methyl, trifluoromethyl, methoxymethyl or trifluoromethoxymethyl, and R¹ represents (C₁-C₆-alkyl)carbonyl, (C₁-C₆-alkoxy)-carbonyl, or (C₁-C₄-alkoxy-C₁-C₄-alkyl)carbonyl, or (C₁-C₆-haloalkyl)carbonyl, (C₁-C₆-haloalkoxy)carbonyl, (halo-C₁-C₄-alkoxy-C₁-C₄-alkyl)carbonyl having in each case 1 to 9 fluorine, chlorine, and/or bromine atoms,
or
(2) a radical of formula (A2) 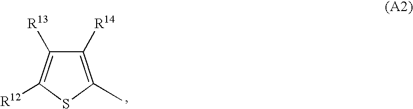
in which
R¹² and R¹³ independently of one another represent hydrogen, halogen, C₁-C₄-alkyl, or C₁-C₄-haloalkyl having in each case 1 to 5 halogen atoms, and
R¹⁴ represents halogen, cyano or C₁-C₄-alkyl; or represents C₁-C₄-haloalkyl or C₁-C₄-haloalkoxy having in each case 1 to 5 halogen atoms,
with the proviso that R¹⁴ does not represent methyl if R¹² and R¹³ represent hydrogen or methyl and R¹ and R² simultaneously represent hydrogen,
or
(3) a radical of formula (A3) 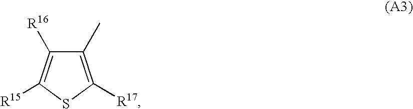
in which
R¹⁵ and R¹⁶ independently of one another represent hydrogen, halogen, C₁-C₄-alkyl, or C₁-C₄-haloalkyl having 1 to 5 halogen atoms, and
R¹⁷ represents hydrogen, C₁-C₄-alkyl, or C₁-C₄-haloalkyl having 1 to 5 halogen atoms,
or
(4) a radical of formula (A4) 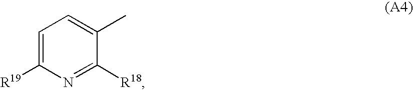
in which
R¹⁸ represents halogen, hydroxyl, cyano, C₁-C₄-alkyl, C₁-C₄-alkoxy, or C₁-C₄-alkylthio; or represents, C₁-C₄-haloalkyl, C₁-C₄-haloalkylthio, or C₁-C₄-haloalkoxy having in each case 1 to 5 halogen atoms, and
R¹⁹ represents hydrogen, halogen, cyano, C₁-C₄-alkyl, C₁-C₄-alkoxy, or C₁-C₄-alkylthio; represents C₁-C₄-haloalkyl or C₁-C₄-haloalkoxy having in each case 1 to 5 halogen atoms; or represents C₁-C₄-alkylsulphinyl or C₁-C₄-alkylsulphonyl,
with the provisos that
(a) R¹⁸ does not represent trifluoromethyl, methyl, chlorine, or methylthio if R¹⁹ represents hydrogen and R¹ and R² simultaneously represent hydrogen, and
(b) R¹⁸ does not represent methyl, difluorochloromethyl, trifluoromethyl; difluoromethyl, chlorine, or bromine if R¹⁹ represents hydrogen and R¹ represents (C₁-C₆-alkyl)carbonyl, (C₁-C₆-alkoxy)carbonyl, or (C₁-C₄-alkoxy-C₁-C₄-alkyl)carbonyl, or (C₁-C₆-haloalkyl)carbonyl, (C₁-C₆-haloalkoxy)carbonyl, or (halo-C₁-C₄-alkoxy-C₁-C₄-alkyl)carbonyl having in each case 1 to 9 fluorine, chlorine, and/or bromine atoms,
or
(5) a radical of formula (A5) 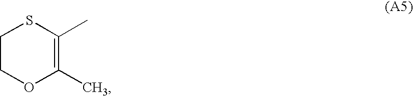
with the proviso that R¹ and R² do not simultaneously represent hydrogen if A represents a radical of formula (A5),
or
(6) a radical of formula (A6) 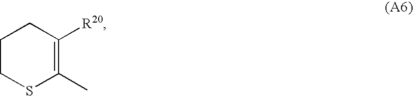
in which R²⁰ represents C₁-C₄-alkyl, or C₁-C₄-haloalkyl having 1 to 5 halogen atoms,
or
(7) a radical of formula (A7) 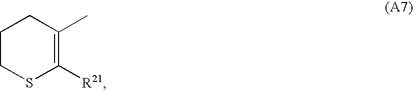
in which R²¹ represents C₁-C₄-alkyl or C₁-C₄-haloalkyl having 1 to 5 halogen atoms,
or
(8) a radical of formula (A8) 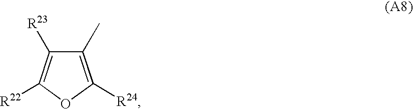
in which
R²² and R²³ independently of one another represent hydrogen, halogen, amino, C₁-C₄-alkyl, or C₁-C₄-haloalkyl having 1 to 5 halogen atoms, and
R²⁴ represents hydrogen, C₁-C₄-alkyl, or C₁-C₄-haloalkyl having 1 to 5 halogen atoms,
with the proviso that R²⁴ does not represent methyl if R²² and R²³ represent hydrogen or methyl and R¹ and R² simultaneously represent hydrogen,
or
(9) a radical of formula (A9) 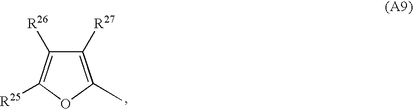
in which
R²⁵ and R²⁶ independently of one another represent hydrogen, halogen, amino, nitro, C₁-C₄-alkyl, or C₁-C₄-haloalkyl having 1 to 5 halogen atoms, and
R²⁷ represents halogen, C₁-C₄-alkyl, or C₁-C₄-haloalkyl having 1 to 5 halogen atoms,
or
(10) a radical of formula (A10) 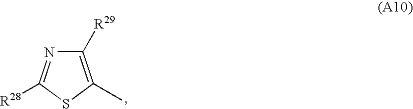
in which
R²⁸ represents hydrogen, halogen, amino, C₁-C₄-alkylamino, di-(C₁-C₄-alkyl)amino, cyano, C₁-C₄-alkyl, or C₁-C₄-haloalkyl having 1 to 5 halogen atoms, and
R²⁹ represents halogen, hydroxyl, C₁-C₄-alkyl, C₁-C₄-alkoxy, or C₃-C₆-cycloalkyl; or represents C₁-C₄-haloalkyl or C₁-C₄-haloalkoxy having in each case 1 to 5 halogen atoms,
with the provisos that
(a) R²⁹ does not represent trifluoromethyl, difluoromethyl, methyl, or ethyl if R²⁸ represents hydrogen or methyl and R¹ and R² simultaneously represent hydrogen, and
(b) R²⁹ does not represent methyl, difluorochloromethyl, trifluoromethyl, difluoromethyl, chlorine, or bromine if R²⁸ represents methyl, trifluoromethyl, methoxymethyl or trifluoromethoxymethyl and R¹ represents (C₁-C₆-alkyl)carbonyl, (C₁-C₆-alkoxy)carbonyl, or (C₁-C₄-alkoxy-C₁-C₄-alkyl)carbonyl, or (C₁-C₆-haloalkyl)-carbonyl, (C₁-C₆-haloalkoxy)carbonyl, or (halo-C₁-C₄-alkoxy-C₁-C₄-alkyl)carbonyl having in each case 1 to 9 fluorine, chlorine, and/or bromine atoms,
or
(11) a radical of formula (A11) 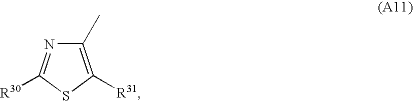
in which
R³⁰ represents hydrogen, halogen, amino, C₁-C₄-alkylamino, di-(C₁-C₄-alkyl)amino, cyano, C₁-C₄-alkyl, or C₁-C₄-haloalkyl having 1 to 5 halogen atoms, and
R³¹ represents halogen, C₁-C₄-alkyl, or C₁-C₄-haloalkyl having 1 to 5 halogen atoms,
or
(12) a radical of formula (A12) 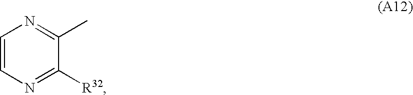
in which R³² represents hydrogen, halogen, C₁-C₄-alkyl, or C₁-C₄-haloalkyl having 1 to 5 halogen atoms,
with the proviso that R³² does not represent chlorine if R¹ and R² simultaneously represent hydrogen,
or
(13) a radical of formula (A13) 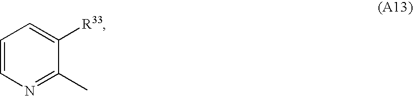
in which R³³ represents halogen, hydroxyl, C₁-C₄-alkyl, C₁-C₄-alkoxy, or C₁-C₄-alkylthio; or represents C₁-C₄-haloalkyl, C₁-C₄-haloalkylthio, or C₁-C₄-haloalkoxy having in each case 1 to 5 halogen atoms,
or
(14) a radical of formula (A14) 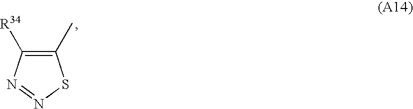
in which R³⁴ represents C₁-C₄-alkyl.

12. A 1,3-dimethylbutylcarboxanilide of formula (I) according to claim 11 in which
R¹ represents hydrogen, C₁-C₆-alkyl, C₁-C₄-alkylsulphinyl, C₁-C₄-alkylsulphonyl, C₁-C₃-alkoxy-C₁-C₃-alkyl, or C₃-C₆-cycloalkyl; represents C₁-C₄-haloalkyl, C₁-C₄-haloalkylthio, C₁-C₄-haloalkylsulphinyl, C₁-C₄-haloalkylsulphonyl, halo-C₁-C₃-alkoxy-C₁-C₃-alkyl, or C₃-C₈-halocycloalkyl having in each case 1 to 9 fluorine, chlorine, and/or bromine atoms; represents formyl, formyl-C₁-C₃-alkyl, (C₁-C₃-alkyl)carbonyl-C₁-C₃-alkyl, or (C₁-C₃-alkoxy)carbonyl-C₁-C₃-alkyl; represents halo-(C₁-C₃-alkyl)carbonyl-C₁-C₃-alkyl or halo-(C₁-C₃-alkoxy)-carbonyl-C₁-C₃-alkyl having in each case 1 to 13 fluorine, chlorine, and/or bromine atoms; represents (C₁-C₆-alkyl)carbonyl, (C₁-C₄-alkoxy)carbonyl, (C₁-C₃-alkoxy-C₁-C₃-alkyl)carbonyl, or (C₃-C₆-cycloalkyl)carbonyl; represents (C₁-C₄-haloalkyl)carbonyl, (C₁-C₄-haloalkoxy)carbonyl, (halo-C₁-C₃-alkoxy-C₁-C₃-alkyl)carbonyl, or (C₃-C₆-halocycloalkyl)carbonyl having in each case 1 to 9 fluorine, chlorine, and/or bromine atoms; or represents —C(═O)C(═O)R³, —CONR⁴R⁵, or —CH₂NR⁶R⁷,
R² represents hydrogen, fluorine, chlorine, methyl, or trifluoromethyl,
R³ represents hydrogen, C₁-C₆-alkyl, C₁-C₄-alkoxy, C₁-C₃-alkoxy-C₁-C₃-alkyl, or C₃-C₆-cycloalkyl; represents C₁-C₄-haloalkyl, C₁-C₄-haloalkoxy, halo-C₁-C₃-alkoxy-C₁-C₃-alkyl, or C₃-C₆-halocycloalkyl having in each case 1 to 9 fluorine, chlorine, and/or bromine atoms,
R⁴ and R⁵ independently of one another represent hydrogen, C₁-C₆-alkyl, C₁-C₃-alkoxy-C₁-C₃-alkyl, or C₃-C₆-cycloalkyl; or represent C₁-C₄-haloalkyl, halo-C₁-C₃-alkoxy-C₁-C₃-alkyl, or C₃-C₆-halocycloalkyl having in each case 1 to 9 fluorine, chlorine, and/or bromine atoms; or R⁴ and R⁵ together with the nitrogen atom to which they are attached form a saturated heterocycle having 5 or 6 ring atoms that is optionally mono- to tetrasubstituted by identical or different substituents selected from the group consisting of halogen and C₁-C₄-alkyl, where the heterocycle optionally contains 1 or 2 further non-adjacent heteroatoms selected from the group consisting of oxygen, sulphur, and NR⁸,
R⁶ and R⁷ independently of one another represent hydrogen, C₁-C₆-alkyl, or C₃-C₆-cycloalkyl; or represent C₁-C₄-haloalkyl or C₃-C₆-halocycloalkyl having in each case 1 to 9 fluorine, chlorine, and/or bromine atoms; or R⁶ and R⁷ together with the nitrogen atom to which they are attached form a saturated heterocycle having 5 or 6 ring atoms that is optionally mono- or poly-substituted by identical or different substituents selected from the group consisting of halogen and C₁-C₄-alkyl, where the heterocycle optionally contains 1 or 2 further non-adjacent heteroatoms selected from the group consisting of oxygen, sulphur, and NR⁸,
R⁸ represents hydrogen or C₁-C₄-alkyl, and
A represents
(1) a radical of formula (A1) 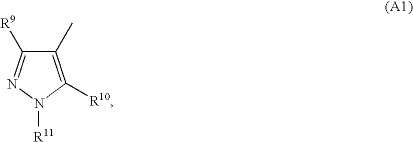
in which
R⁹ represents hydrogen, hydroxyl, formyl, cyano, fluorine, chlorine, bromine, methyl, ethyl, isopropyl, methoxy, ethoxy, methylthio, ethylthio, or cyclopropyl; represents C₁-C₂-haloalkyl or C₁-C₂-haloalkoxy having in each case 1 to 5 fluorine, chlorine, and/or bromine atoms; or represents trifluoromethylthio, difluoromethylthio, aminocarbonyl, aminocarbonylmethyl, or aminocarbonylethyl,
R¹⁰ represents hydrogen, chlorine, bromine, iodine, methyl, ethyl, methoxy, ethoxy, methylthio, ethylthio, or C₁-C₂-haloalkyl having 1 to 5 halogen atoms, and
R¹¹ represents hydrogen, methyl, ethyl, n-propyl, isopropyl, C₁-C₂-haloalkyl having 1 to 5 fluorine, chlorine, and/or bromine atoms, hydroxymethyl, hydroxyethyl, cyclopropyl, cyclopentyl, cyclohexyl, or phenyl,
with the provisos that
(a) R⁹ does not represent trifluoromethyl, difluoromethyl, methyl, or ethyl if R¹⁰ represents hydrogen or chlorine, R¹¹ represents methyl and R¹ and R² simultaneously represent hydrogen, and
(b) R⁹ does not represent methyl, difluorochloromethyl, trifluoromethyl, difluoromethyl, chlorine, or bromine if R¹⁰ represents hydrogen, fluorine, trifluoromethyl, or methyl, R¹¹ represents methyl, trifluoromethyl, methoxymethyl, or trifluoromethoxymethyl, and R¹ represents (C₁-C₆-alkyl)carbonyl, (C₁-C₆-alkoxy)carbonyl, or (C₁-C₄-alkoxy-C₁-C₄-alkyl)carbonyl, or (C₁-C₆-haloalkyl)carbonyl, (C₁-C₆-haloalkoxy)carbonyl, or (halo-C₁-C₄-alkoxy-C₁-C₄-alkyl)carbonyl having in each case 1 to 9 fluorine, chlorine, and/or bromine atoms,
or
(2) a radical of formula (A2) 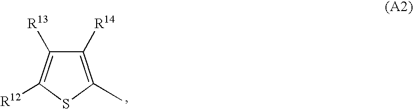
in which
R¹² and R¹³ independently of one another represent hydrogen, fluorine, chlorine, bromine, methyl, ethyl, or C₁-C₂-haloalkyl having 1 to 5 fluorine, chlorine, and/or bromine atoms, and
R¹⁴ represents fluorine, chlorine, bromine, iodine, cyano, methyl, or ethyl; or represents C₁-C₂-haloalkyl or C₁-C₂-haloalkoxy having in each case 1 to 5 fluorine, chlorine, and/or bromine atoms,
with the proviso that R¹⁴ does not represent methyl if R¹² and R¹³ represent hydrogen or methyl and R¹ and R² simultaneously represent hydrogen,
or
(3) a radical of formula (A3) 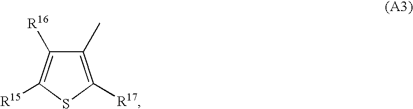
in which
R¹⁵ and R¹⁶ independently of one another represent hydrogen, fluorine, chlorine, bromine, methyl, ethyl, or C₁-C₂-haloalkyl having 1 to 5 fluorine, chlorine, and/or bromine atoms, and
R¹⁷ represents hydrogen, methyl, ethyl, or C₁-C₂-haloalkyl having 1 to 5 fluorine, chlorine, and/or bromine atoms,
or
(4) a radical of formula (A4) 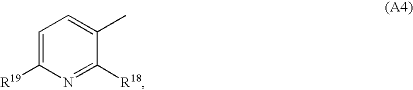
in which
R¹⁸ represents fluorine, chlorine, bromine, iodine, hydroxyl, cyano, C₁-C₄-alkyl, methoxy, ethoxy, methylthio, ethylthio, difluoromethylthio, or trifluoromethylthio; or represents C₁-C₂-haloalkyl or C₁-C₂-haloalkoxy having in each case 1 to 5 fluorine, chlorine, and/or bromine atoms, and
R¹⁹ represents hydrogen, fluorine, chlorine, bromine, iodine, cyano, C₁-C₄-alkyl, methoxy, ethoxy, methylthio, or ethylthio; represents C₁-C₂-haloalkyl or C₁-C₂-haloalkoxy having in each case 1 to 5 fluorine, chlorine, and/or bromine atoms; or represents C₁-C₂-alkylsulphinyl or C₁-C₂-alkylsulphonyl,
with the provisos that
(a) R¹⁸ does not represent trifluoromethyl, methyl, chlorine, or methylthio if R¹⁹ represents hydrogen, and
(b) R¹⁸ does not represent methyl, difluorochloromethyl, trifluoromethyl, difluoromethyl, chlorine, or bromine if R¹⁹ represents hydrogen and R¹ represents (C₁-C₆-alkyl)carbonyl, (C₁-C₆-alkoxy)carbonyl, or (C₁-C₄-alkoxy-C₁-C₄-alkyl)carbonyl, or (C₁-C₆-haloalkyl)carbonyl, (C₁-C₆-haloalkoxy)carbonyl, or (halo-C₁-C₄-alkoxy-C₁-C₄-alkyl)carbonyl having in each case 1 to 9 fluorine, chlorine, and/or bromine atoms,
or
(5) a radical of formula (A5) 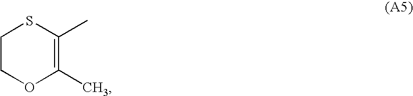
with the proviso that R¹ and R² do not simultaneously represent hydrogen if A represents a radical of formula (A5),
or
(6) a radical of formula (A8) 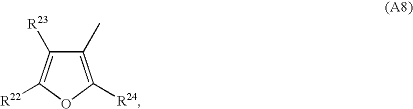
in which
R²² and R²³ independently of one another represent hydrogen, fluorine, chlorine, bromine, amino, methyl, ethyl, or C₁-C₂-haloalkyl having 1 to 5 fluorine, chlorine, and/or bromine atoms, and
R²⁴ represents hydrogen, methyl, ethyl, or C₁-C₂-haloalkyl having 1 to 5 fluorine, chlorine, and/or bromine atoms,
or
(7) a radical of formula (A9) 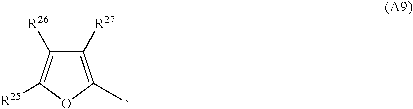
in which
R²⁵ and R²⁶ independently of one another represent hydrogen, fluorine, chlorine, bromine, amino, nitro, methyl, ethyl, or C₁-C₂-haloalkyl having 1 to 5 fluorine, chlorine, and/or bromine atoms, and
R²⁷ represents fluorine, chlorine, bromine, methyl, ethyl, or C₁-C₂-haloalkyl having 1 to 5 fluorine, chlorine, and/or bromine atoms,
or
(8) a radical of formula (A10) 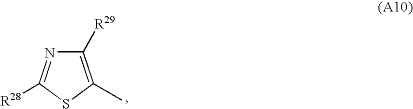
in which
R²⁸ represents hydrogen, fluorine, chlorine, bromine, amino, C₁-C₄-alkylamino, di-(C₁-C₄-alkyl)amino, cyano, methyl, ethyl, or C₁-C₂-haloalkyl having 1 to 5 fluorine, chlorine, and/or bromine atoms, and
R²⁹ represents fluorine, chlorine, bromine, hydroxyl, methyl, ethyl; methoxy, ethoxy, or cyclopropyl; or represents C₁-C₂-haloalkyl or C₁-C₂-haloalkoxy having in each case 1 to 5 fluorine, chlorine, and/or bromine atoms,
with the provisos that
(a) R²⁹ does not represent trifluoromethyl, difluoromethyl, methyl, or ethyl if R²⁸ represents hydrogen or methyl and R¹ and R² simultaneously represent hydrogen, and
(b) R²⁹ does not represent methyl, difluorochloromethyl, trifluoromethyl, difluoromethyl, chlorine, or bromine if R¹¹ represents methyl, trifluoromethyl, methoxymethyl, or trifluoromethoxymethyl and R¹ represents (C₁-C₆-alkyl)carbonyl, (C₁-C₆-alkoxy)-carbonyl, or (C₁-C₄-alkoxy-C₁-C₄-alkyl)carbonyl, or (C₁-C₆-haloalkyl)carbonyl, (C₁-C₆-haloalkoxy)carbonyl, or (halo-C₁-C₄-alkoxy-C₁-C₄-alkyl)carbonyl having in each case 1 to 9 fluorine, chlorine, and/or bromine atoms,
or
(9) a radical of formula (A11) 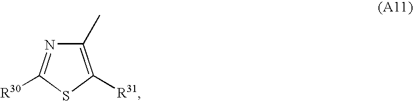
in which
R³⁰ represents hydrogen, fluorine, chlorine, bromine, amino, C₁-C₄-alkylamino, di-(C₁-C₄-alkyl)amino, cyano, methyl, ethyl, or C₁-C₂-haloalkyl having 1 to 5 fluorine, chlorine and/or bromine atoms, and
R³¹ represents fluorine, chlorine, bromine, methyl, ethyl, or C₁-C₂-haloalkyl having 1 to 5 fluorine, chlorine, and/or bromine atoms,
or
(10) a radical of formula (A12) 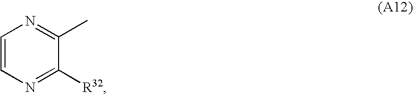
in which R³² represents hydrogen, fluorine, chlorine, bromine, methyl, ethyl, or C₁-C₂-haloalkyl having 1 to 5 fluorine, chlorine, and/or bromine atoms,
with the proviso that R³² does not represent chlorine if R¹ and R² simultaneously represent hydrogen,
or
(11) a radical of formula (A13) 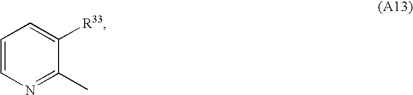
in which R³³ represents fluorine, chlorine, bromine, iodine, hydroxyl, C₁-C₄-alkyl, methoxy, ethoxy, methylthio, ethylthio, difluoromethylthio, or trifluoromethylthio; or represents C₁-C₂-haloalkyl or C₁-C₂-haloalkoxy having in each case 1 to 5 fluorine, chlorine, and/or bromine atoms.

13. A 1,3-dimethylbutylcarboxanilide of formula (I) according to claim 11 in which R¹ represents formyl.

14. A 1,3-dimethylbutylcarboxanilide of formula (I) according to claim 11 in which R¹ represents —C(═O)C(═O)R³, where R³ is as defined in claim 11.

15. A 1,3-dimethylbutylcarboxanilide of formula (I) according to claim 11 in which A represents A1.

16. A process for preparing compounds of formula (I) according to claim 11 comprising
(a) reacting a carboxylic acid derivative of formula (II) 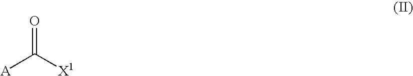
in which
A is as defined for formula (I) in claim 11, and
X¹ represents halogen or hydroxyl,
with an aniline derivative of formula (III) 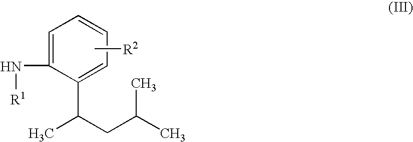
in which R¹ and R² are as defined for formula (I) in claim 11, optionally in the presence of a catalyst, optionally in the presence of a condensing agent, optionally in the presence of an acid binder, and optionally in the presence of a diluent,
or
(b) reacting a hexylcarboxanilide of formula (I-a) 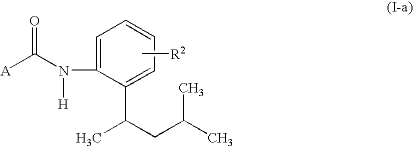
in which A and R² are as defined for formula (I) in claim 11,
with a halide of formula (IV)
R^{1-A}—X (IV)
in which
X² represents chlorine, bromine, or iodine, and
R¹ represents C₁-C₈-alkyl, C₁-C₆-alkylsulphinyl, C₁-C₆-alkylsulphonyl, C₁-C₄-alkoxy-C₁-C₄-alkyl, or C₃-C₈-cycloalkyl; represents C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, or C₃-C₈-halocycloalkyl having in each case 1 to 9 fluorine, chlorine, and/or bromine atoms; represents formyl, formyl-C₁-C₃-alkyl, (C₁-C₃-alkyl)carbonyl-C₁-C₃-alkyl, or (C₁-C₃-alkoxy)-carbonyl-C₁-C₃-alkyl; represents halo-(C₁-C₃-alkyl)carbonyl-C₁-C₃-alkyl or halo-(C₁-C₃-alkoxy)carbonyl-C₁-C₃-alkyl having in each case 1 to 13 fluorine, chlorine, and/or bromine atoms; represents (C₁C₈-alkyl)carbonyl, (C₁-C₈-alkoxy)carbonyl, (C₁-C₄-alkoxy-C₁-C₄-alkyl)carbonyl, or (C₃-C₈-cycloalkyl)carbonyl; represents (C₁-C₆-haloalkyl)carbonyl, (C₁-C₆-haloalkoxy)-carbonyl, (halo-C₁-C₄-alkoxy-C₁-C₄-alkyl)carbonyl, or (C₃-C₈-halocycloalkyl)carbonyl having in each case 1 to 9 fluorine, chlorine, and/or bromine atoms; or represents —C(═O)C(═O)R³, CONR⁴R⁵, or —CH₂NR⁶R⁷,
where R³, R⁴, R⁵, R⁶ and R⁷ are as defined for formula (I) in claim 11,
in the presence of a base and in the presence of a diluent.

17. A composition for controlling unwanted microorganisms comprising one or more 1,3-dimethylbutylcarboxanilides of formula (I) according to claim 11 and one or more extenders and/or surfactants.

18. A method for controlling unwanted microorganisms comprising applying an effective amount of a 1,3-dimethylbutylcarboxanilide of formula (I) according to claim 11 to the microorganisms and/or their habitat.

19. A process for preparing compositions for controlling unwanted microorganisms comprising mixing one or more 1,3-dimethylbutylcarboxanilides of formula (I) according to claim 11 with one or more extenders and/or surfactants.
